(19) United States
(12) Patent Application Publication
(10) Pub. No.: US 2025/0286800 A1
(43) Pub. Date: Sep. 11, 2025

(54) MITIGATING JITTER IN COMMUNICATIONS

(71) Applicant: QUALCOMM Incorporated, San Diego, CA (US)

(72) Inventors: Hyun Yong LEE, San Diego, CA (US); Peerapol TINNAKORNSRISUPHAP, San Diego, CA (US); Prashanth Haridas HANDE, San Diego, CA (US); Ravi AGARWAL, San Diego, CA (US); Mickael MONDET, Louannec (FR); Diana MAAMARI, San Diego, CA (US)

(21) Appl. No.: 18/759,474

(22) Filed: Jun. 28, 2024

Related U.S. Application Data
(60) Provisional application No. 63/563,202, filed on Mar. 8, 2024.

(51) Int. Cl. H04L 43/087; H04L 69/28

(52) U.S. Cl. CPC H04L 43/087; H04L 69/28

(57) ABSTRACT

Methods, systems, and devices for wireless communications are described. An application server (AS) may generate one or more packet data unit (PDU) sets of a first periodic burst transmission. The first periodic burst transmission may correspond to a first delivery deadline at a user equipment (UE) during a jitter window. The jitter window may span a time period prior to and after a first arrival time associated with the one or more PDU sets. The AS may buffer at least a portion of the one or more PDU sets for a first duration of the jitter window. The first duration may correspond to a threshold percentage of the jitter window. The AS may output the one or more PDU sets based on expiration of the first duration and prior to the first delivery deadline.

### CROSS REFERENCE

The present Application for Patent claims the benefit of U.S. Provisional Patent Application No. 63/563,202 by LEE et al., entitled “MITIGATING JITTER IN COMMUNICATIONS,” filed Mar. 8, 2024, assigned to the assignee hereof, and expressly incorporated by reference herein.

### FIELD OF TECHNOLOGY

The following relates to wireless communications, including mitigating jitter in communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support mitigating jitter in communications. For example, the described techniques provide for generating, at an application server (AS), one or more packet data unit (PDU) sets of a first periodic burst transmission. The first periodic burst transmission may correspond to a first delivery deadline at a user equipment (UE) during a jitter window. The jitter window may span a time period prior to and after a first arrival time associated with the one or more PDU sets. The AS may buffer at least a portion of the one or more PDU sets for a first duration of the jitter window. The first duration may correspond to a threshold percentage of the jitter window. The AS may output the one or more PDU sets based on expiration of the first duration and prior to the first delivery deadline.

A method for wireless communications by an AS is described. The method may include generating one or more PDU sets of a first periodic burst transmission, the first periodic burst transmission corresponding to a first delivery deadline at a UE during a jitter window, where the jitter window spans a time period prior to and after a first arrival time associated with the one or more PDU sets, buffering at least a portion of the one or more PDU sets for a first duration of the jitter window, where the first duration corresponds to a threshold percentage of the jitter window, and outputting the one or more PDU sets upon expiration of the first duration and prior to the first delivery deadline.

An AS for wireless communications is described. The AS may include one or more memories storing processor executable code, and one or more processors coupled with the one or more memories. The one or more processors may individually or collectively be operable to execute the code to cause the AS to generate one or more PDU sets of a first periodic burst transmission, the first periodic burst transmission corresponding to a first delivery deadline at a UE during a jitter window, where the jitter window spans a time period prior to and after a first arrival time associated with the one or more PDU sets, buffer at least a portion of the one or more PDU sets for a first duration of the jitter window, where the first duration corresponds to a threshold percentage of the jitter window, and output the one or more PDU sets upon expiration of the first duration and prior to the first delivery deadline.

Another AS for wireless communications is described. The AS may include means for generating one or more PDU sets of a first periodic burst transmission, the first periodic burst transmission corresponding to a first delivery deadline at a UE during a jitter window, where the jitter window spans a time period prior to and after a first arrival time associated with the one or more PDU sets, means for buffering at least a portion of the one or more PDU sets for a first duration of the jitter window, where the first duration corresponds to a threshold percentage of the jitter window, and means for outputting the one or more PDU sets upon expiration of the first duration and prior to the first delivery deadline.

A non-transitory computer-readable medium storing code for wireless communications is described. The code may include instructions executable by one or more processors to generate one or more PDU sets of a first periodic burst transmission, the first periodic burst transmission corresponding to a first delivery deadline at a UE during a jitter window, where the jitter window spans a time period prior to and after a first arrival time associated with the one or more PDU sets, buffer at least a portion of the one or more PDU sets for a first duration of the jitter window, where the first duration corresponds to a threshold percentage of the jitter window, and output the one or more PDU sets upon expiration of the first duration and prior to the first delivery deadline.

Some examples of the method, ASs, and non-transitory computer-readable medium described herein may further include operations, features, means, or instructions for obtaining control signaling including assistance information associated with the UE, the assistance information indicating the first delivery deadline, a periodicity associated with the first periodic burst transmission, the jitter window, the first duration, or any combination thereof, where buffering at least the portion of the one or more PDU sets may be in accordance with the assistance information.

Some examples of the method, ASs, and non-transitory computer-readable medium described herein may further include operations, features, means, or instructions for outputting a time sensitive communication (TSC) message including an indication of the jitter window based on generating the one or more PDU sets of the first periodic burst transmission. In some examples of the method, ASs, and non-transitory computer-readable medium described herein, buffering the portion of the one or more PDU sets may include operations, features, means, or instructions for starting a timer in response to generating the one or more PDU sets, the timer being set to the first duration, where buffering the portion of the one or more PDU sets may be based on starting the timer, and where outputting the one or more PDU sets may be based on expiration of the timer.

In some examples of the method, ASs, and non-transitory computer-readable medium described herein, buffering the portion of the one or more PDU sets may include operations, features, means, or instructions for identifying a start time associated with the one or more PDU sets in response to generating the one or more PDU sets and delaying the portion of the one or more PDU sets from the identified start time for the first duration, where outputting the one or more PDU sets may be based on the expiration of the first duration.

Some examples of the method, ASs, and non-transitory computer-readable medium described herein may further include operations, features, means, or instructions for measuring a second jitter window associated with communication of a second periodic burst transmission, the second periodic burst transmission being prior to the first periodic burst transmission and estimating the jitter window associated with the first periodic burst transmission based on the second jitter window.

Some examples of the method, ASs, and non-transitory computer-readable medium described herein may further include operations, features, means, or instructions for storing the second jitter window based on measuring the second jitter window, where estimating the jitter window may be based on the storing.

In some examples of the method, ASs, and non-transitory computer-readable medium described herein, the second jitter window may be stored according to an extended reality (XR) configuration in a memory of the AS.

Some examples of the method, ASs, and non-transitory computer-readable medium described herein may further include operations, features, means, or instructions for measuring a respective jitter window associated with communication of one or more additional periodic burst transmissions, the one or more additional periodic burst transmissions being prior to the first periodic burst transmission and after the second periodic burst transmission and updating the second jitter window stored in the AS based on measuring the respective jitter windows of each of the one or more additional periodic burst transmissions, where estimating the jitter window may be based on updating the second jitter window.

In some examples of the method, ASs, and non-transitory computer-readable medium described herein, the second jitter window may be based on an operating condition of the AS, a data rate of the second periodic burst transmission, a periodicity of the second periodic burst transmission, or a combination thereof.

Some examples of the method, ASs, and non-transitory computer-readable medium described herein may further include operations, features, means, or instructions for measuring a duration associated with generating the one or more PDU sets of the first periodic burst transmission and estimating the jitter window based on the duration associated with generating the one or more PDU sets.

Some examples of the method, ASs, and non-transitory computer-readable medium described herein may further include operations, features, means, or instructions for estimating the jitter window using the duration may be based on the duration being less than a threshold duration.

In some examples of the method, ASs, and non-transitory computer-readable medium described herein, the duration associated with generating the one or more PDU sets of the first periodic burst transmission may be based on a data rate associated with the first periodic burst transmission, a periodicity of the first periodic burst transmission, or a combination thereof.

Some examples of the method, ASs, and non-transitory computer-readable medium described herein may further include operations, features, means, or instructions for identifying a second jitter window associated with a second periodic burst transmission, the second periodic burst transmission being prior to the first periodic burst transmission, measuring a duration associated with generating the one or more PDU sets of the first periodic burst transmission, and estimating the jitter window based on the duration associated with generating the one or more PDU sets and the second jitter window associated with the second periodic burst transmission.

In some examples of the method, ASs, and non-transitory computer-readable medium described herein, generating the one or more PDU sets may include operations, features, means, or instructions for rendering at least a portion of a video frame associated with XR communications, encoding, based on the rendering, the portion of the video frame, and packetizing, based on the encoding, the portion of the video frame to obtain the one or more PDU sets of the first periodic burst transmission.

In some examples of the method, ASs, and non-transitory computer-readable medium described herein, the first arrival time may be an average arrival time measured across one or more periodic burst transmissions, the one or more periodic burst transmissions occurring prior to the first periodic burst transmission.

A method for wireless communications by a radio access network (RAN) is described. The method may include obtaining a TSC message indicating a jitter window associated with one or more PDU sets of a first periodic burst transmission, where the jitter window spans a time period prior to and after a first arrival time associated with the one or more PDU sets, and where the one or more PDU sets of the first periodic burst transmission correspond to a first delivery deadline at a UE, obtaining at least a portion of the one or more PDU sets of the first periodic burst transmission at a first time, where the first time corresponds to at least a threshold percentage of the jitter window, and outputting the one or more PDU sets prior to the first delivery deadline.

A RAN for wireless communications is described. The RAN may include one or more memories storing processor executable code, and one or more processors coupled with the one or more memories. The one or more processors may individually or collectively be operable to execute the code to cause the RAN to obtain a TSC message indicating a jitter window associated with one or more PDU sets of a first periodic burst transmission, where the jitter window spans a time period prior to and after a first arrival time associated with the one or more PDU sets, and where the one or more PDU sets of the first periodic burst transmission correspond to a first delivery deadline at a UE, obtain at least a portion of the one or more PDU sets of the first periodic burst transmission at a first time, where the first time corresponds to at least a threshold percentage of the jitter window, and output the one or more PDU sets prior to the first delivery deadline.

Another RAN for wireless communications is described. The RAN may include means for obtaining a TSC message indicating a jitter window associated with one or more PDU sets of a first periodic burst transmission, where the jitter window spans a time period prior to and after a first arrival time associated with the one or more PDU sets, and where the one or more PDU sets of the first periodic burst transmission correspond to a first delivery deadline at a UE, means for obtaining at least a portion of the one or more PDU sets of the first periodic burst transmission at a first time, where the first time corresponds to at least a threshold percentage of the jitter window, and means for outputting the one or more PDU sets prior to the first delivery deadline.

A non-transitory computer-readable medium storing code for wireless communications is described. The code may include instructions executable by one or more processors to obtain a TSC message indicating a jitter window associated with one or more PDU sets of a first periodic burst transmission, where the jitter window spans a time period prior to and after a first arrival time associated with the one or more PDU sets, and where the one or more PDU sets of the first periodic burst transmission correspond to a first delivery deadline at a UE, obtain at least a portion of the one or more PDU sets of the first periodic burst transmission at a first time, where the first time corresponds to at least a threshold percentage of the jitter window, and output the one or more PDU sets prior to the first delivery deadline.

Some examples of the method, RANs, and non-transitory computer-readable medium described herein may further include operations, features, means, or instructions for outputting control signaling indicating one or more parameters corresponding to a discontinuous reception (DRX) cycle associated with the UE based on the jitter window, where the one or more parameters include an offset and an on-duration.

In some examples of the method, RANs, and non-transitory computer-readable medium described herein, the offset may be based on the jitter window, a remaining jitter, a jitter associated with communications between the RAN and a user plane function (UPF), a first margin, or a combination thereof, the remaining jitter corresponding to a difference between the jitter window and the threshold percentage of the jitter window and the on-duration may be based on the remaining jitter, the jitter associated with the communications between the RAN and the UPF, a second margin, or a combination thereof.

In some examples of the method, RANs, and non-transitory computer-readable medium described herein, the TSC message further indicates the remaining jitter, the jitter associated with the communications between the RAN and the UPF, or both.

Some examples of the method, RANs, and non-transitory computer-readable medium described herein may further include operations, features, means, or instructions for measuring the remaining jitter, the jitter associated with the communications between the RAN and the UPF, or both, where the DRX cycle may be based on the measuring.

A method for wireless communications by a UPF is described. The method may include obtaining one or more PDU sets of a first periodic burst transmission, the first periodic burst corresponding to a first delivery deadline at a UE during a jitter window, where the jitter window spans a time period prior to and after a first arrival time associated with the one or more PDU sets, buffering at least a portion of the one or more PDU sets for a first duration of the jitter window, where the first duration corresponds to a threshold percentage of the jitter window, and outputting the one or more PDU sets upon based on expiration of the first duration and prior to the first delivery deadline.

A UPF for wireless communications is described. The UPF may include one or more memories storing processor executable code, and one or more processors coupled with the one or more memories. The one or more processors may individually or collectively be operable to execute the code to cause the UPF to obtain one or more PDU sets of a first periodic burst transmission, the first periodic burst corresponding to a first delivery deadline at a UE during a jitter window, where the jitter window spans a time period prior to and after a first arrival time associated with the one or more PDU sets, buffer at least a portion of the one or more PDU sets for a first duration of the jitter window, where the first duration corresponds to a threshold percentage of the jitter window, and output the one or more PDU sets upon based on expiration of the first duration and prior to the first delivery deadline.

Another UPF for wireless communications is described. The UPF may include means for obtaining one or more PDU sets of a first periodic burst transmission, the first periodic burst corresponding to a first delivery deadline at a UE during a jitter window, where the jitter window spans a time period prior to and after a first arrival time associated with the one or more PDU sets, means for buffering at least a portion of the one or more PDU sets for a first duration of the jitter window, where the first duration corresponds to a threshold percentage of the jitter window, and means for outputting the one or more PDU sets upon based on expiration of the first duration and prior to the first delivery deadline.

A non-transitory computer-readable medium storing code for wireless communications is described. The code may include instructions executable by one or more processors to obtain one or more PDU sets of a first periodic burst transmission, the first periodic burst corresponding to a first delivery deadline at a UE during a jitter window, where the jitter window spans a time period prior to and after a first arrival time associated with the one or more PDU sets, buffer at least a portion of the one or more PDU sets for a first duration of the jitter window, where the first duration corresponds to a threshold percentage of the jitter window, and output the one or more PDU sets upon based on expiration of the first duration and prior to the first delivery deadline.

A method for wireless communications by a RAN is described. The method may include obtaining one or more PDU sets of a first periodic burst transmission, the first periodic burst corresponding to a first delivery deadline at a UE during a jitter window, where the jitter window spans a time period prior to and after a first arrival time associated with the one or more PDU sets, buffering at least a portion of the one or more PDU sets for a first duration of the jitter window, where the first duration corresponds to a threshold percentage of the jitter window, and outputting the one or more PDU sets upon based on expiration of the first duration and prior to the first delivery deadline.

A RAN for wireless communications is described. The RAN may include one or more memories storing processor executable code, and one or more processors coupled with the one or more memories. The one or more processors may individually or collectively be operable to execute the code to cause the RAN to obtain one or more PDU sets of a first periodic burst transmission, the first periodic burst corresponding to a first delivery deadline at a UE during a jitter window, where the jitter window spans a time period prior to and after a first arrival time associated with the one or more PDU sets, buffer at least a portion of the one or more PDU sets for a first duration of the jitter window, where the first duration corresponds to a threshold percentage of the jitter window, and output the one or more PDU sets upon based on expiration of the first duration and prior to the first delivery deadline.

Another RAN for wireless communications is described. The RAN may include means for obtaining one or more PDU sets of a first periodic burst transmission, the first periodic burst corresponding to a first delivery deadline at a UE during a jitter window, where the jitter window spans a time period prior to and after a first arrival time associated with the one or more PDU sets, means for buffering at least a portion of the one or more PDU sets for a first duration of the jitter window, where the first duration corresponds to a threshold percentage of the jitter window, and means for outputting the one or more PDU sets upon based on expiration of the first duration and prior to the first delivery deadline.

A non-transitory computer-readable medium storing code for wireless communications is described. The code may include instructions executable by one or more processors to obtain one or more PDU sets of a first periodic burst transmission, the first periodic burst corresponding to a first delivery deadline at a UE during a jitter window, where the jitter window spans a time period prior to and after a first arrival time associated with the one or more PDU sets, buffer at least a portion of the one or more PDU sets for a first duration of the jitter window, where the first duration corresponds to a threshold percentage of the jitter window, and output the one or more PDU sets upon based on expiration of the first duration and prior to the first delivery deadline.

### BRIEF DESCRIPTION OF THE DRAWINGS

FIG. 1 shows an example of a wireless communications system that supports mitigating jitter in communications in accordance with one or more aspects of the present disclosure.

FIG. 2 shows an example of a wireless communications system that supports mitigating jitter in communications in accordance with one or more aspects of the present disclosure.

FIG. 3 shows an example of a communications timeline that supports mitigating jitter in communications in accordance with one or more aspects of the present disclosure.

FIG. 4 shows an example of a communications timeline that supports mitigating jitter in communications in accordance with one or more aspects of the present disclosure.

FIG. 5 shows an example of a process flow that supports mitigating jitter in communications in accordance with one or more aspects of the present disclosure.

FIG. 6A shows an example of a buffering diagram that supports mitigating jitter in communications in accordance with one or more aspects of the present disclosure.

FIG. 6B shows an example of a buffering diagram that supports mitigating jitter in communications in accordance with one or more aspects of the present disclosure.

FIG. 7 shows an example of a process flow that supports mitigating jitter in communications in accordance with one or more aspects of the present disclosure.

FIG. 8 shows an example of a process flow that supports mitigating jitter in communications in accordance with one or more aspects of the present disclosure.

FIGS. 9 and 10 show block diagrams of devices that support mitigating jitter in communications in accordance with one or more aspects of the present disclosure.

FIG. 11 shows a block diagram of a communications manager that supports mitigating jitter in communications in accordance with one or more aspects of the present disclosure.

FIG. 12 shows a diagram of a system including a device that supports mitigating jitter in communications in accordance with one or more aspects of the present disclosure.

FIGS. 13 through 18 show flowcharts illustrating methods that support mitigating jitter in communications in accordance with one or more aspects of the present disclosure.

### DETAILED DESCRIPTION

In some wireless communications systems, a user equipment (UE) may support extended reality (XR) communications, where, while operating an XR application, the UE may communicate with an application server (AS) of a network. For example, the AS may generate (e.g., render, encode, and packetize an XR frame) a periodic burst transmission (e.g., one or more packet data unit (PDU) sets) associated with the XR application at the UE. Accordingly, in response to generating the periodic burst transmission, the AS may transmit the periodic burst transmission to a user plane function (UPF) of the network, where the UPF may proceed to forward the periodic burst transmission to a radio access network (RAN) that is serving the UE. Based on receiving the periodic burst transmission, the RAN may forward the periodic burst transmission to the UE.

In some cases, the communication flow between the UE and the AS (e.g., AS to UPF to RAN to UE) may be associated with a jitter window (e.g., a time period during which a periodic burst transmission may arrive), where the jitter window may span a time period prior to and after an average arrival time associated with periodic burst transmissions across the communication flow (e.g., a minimum time period from the average arrival time and a maximum time period from the average arrival time). In such cases, however, if the jitter window spans a relatively large time period, the UE may operate in a connected mode (e.g., on mode) for an increased amount of time, thereby reducing power savings at the UE. Thus, techniques may be desired to reduce the effects of jitter during communications.

According to the techniques described herein, the AS may buffer (e.g., delay) a portion of the periodic burst transmission (e.g., one or more PDU sets) for a threshold percentage of the jitter window in order to mitigate the effects of the jitter during the communications, thereby enabling the UE to reduce the quantity of time operating in the connected mode and resulting in power savings at the UE. For example, the AS may generate one or more PDU sets of a first periodic burst transmission, where the first periodic burst transmission may be associated with a first delivery deadline at the UE during a jitter window. Accordingly, in some examples, the AS may buffer at least a portion of the one or more PDU sets for a first duration of the jitter window, where the first duration corresponds to a threshold percentage (e.g., 90%, 99%, 100%) of the jitter window. That is, the AS may delay at least a portion of the one or more PDU sets (e.g., one or more PDU sets generated prior to a threshold time) such that the arrival time of the first periodic burst transmission may be deterministic.

In response to buffering the portion of the one or more PDU sets, the AS may output the one or more PDU sets to the UPF, where the UPF may forward the one or more PDU sets to the RAN. In such examples, the RAN may configure the UE with a discontinuous reception (DRX) cycle that includes an on-duration and an offset that is based on the jitter window and the buffering of the first periodic transmission. In such examples, the DRX cycle may include a relatively smaller on-duration, thereby enabling the UE to save power. In some cases, the UPF or RAN may buffer (e.g., delay) a portion of the periodic burst transmission (e.g., one or more PDU sets) for a threshold percentage of the jitter window in order to mitigate the effects of the jitter during the communications, thereby enabling the UE to reduce the quantity of time operating in the connected mode and resulting in power savings at the UE.

Aspects of the disclosure are initially described in the context of wireless communications systems. Additional aspects of the disclosure are described in the context of communications timelines, process flows, and block diagrams. Aspects of the disclosure are further illustrated by and described with reference to apparatus diagrams, system diagrams, and flowcharts that relate to mitigating jitter in communications.

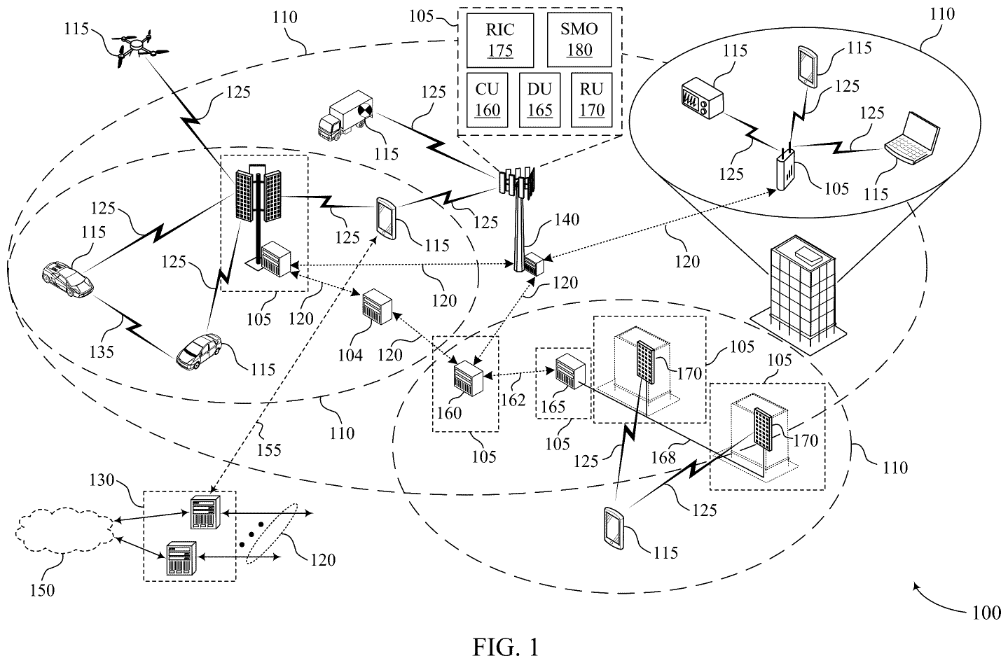

FIG. 1 shows an example of a wireless communications system 100 that supports mitigating jitter in communications in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a RAN node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a UPF). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some examples of the wireless communications system 100, the UE 115 may support XR communications, where, during such XR communications, the UE 115 may communicate with an AS. The AS may generate one or more PDU sets of a periodic burst (e.g., a video frame) that is associated with an application at the UE 115 (e.g., an XR application). In communications with XR applications, the jitter window (e.g., burst arrival time (BAT)) at a network (e.g., 5G network) may be quasi-periodic (e.g., periodic with jitter). For example, a communication flow between the UE 115-a and the AS may be associated with a jitter window, where the jitter window may be a statistical calculation of arrival times of one or more periodic burst transmissions over the communication flow. Accordingly, the jitter window of the communication flow may be associated with a minimum arrival time of a periodic burst (e.g., the earliest time a periodic burst may arrive at the UE 115 over the communication flow), an average arrival time of a periodic burst transmission (e.g., when the average periodic burst may arrive at the UE 115 over the communication flow), and a maximum arrival time of a periodic burst transmission (e.g., the latest time a periodic burst may arrive at the UE 115 over the communication flow).

Further, the jitter window may be modeled according to a truncated gaussian distribution (e.g., a Gaussian distribution with mean: Oms, standard deviation (STD)), where, as an illustrative example, the jitter window may be a range of [−4,4] milliseconds (ms) (baseline) or [−5,5] ms (optional) centered around an average arrival time for the periodic burst transmission.

For XR applications, the jitter window may be relatively large, as compared to other communication flows for other types of data or applications. For example, the range of jitter may use 48% of an XR message periodicity (e.g., jitter=8 ms vs. XR periodicity=16.666 ms (60 frames per second (fps))). As such, the jitter may significantly degrade the 5G system performance, including capacity and power consumption of the UE115, and therefore be unable to satisfy one or more quality of service (QoS) metrics of the periodic burst transmissions, such as being unable to satisfy a packet delay budget (PDB) or PDU set delay budget (PSDB) associated with the XR data. As a result, current system performance may suffer from the jitter associated with XR communications, for example, by being unable to configure extended connected mode DRX (eCDRX) modes for the UE 115 (e.g., resulting in a loss of power savings at the UE 115-a), configure semi persistent scheduling (SPS) or configured grants (CG) (e.g., resulting in increased latency in the wireless communications).

As described herein, the jitter window associated with downlink XR traffic (e.g., periodic burst transmissions from the AS towards the UE) may be quasi-periodic (e.g., periodic with jitter). In such examples, the source of the jitter may be based on varying periodic burst (e.g., video frame) generation times at the AS. For example, to generate a periodic burst, the AS may render at least a portion of a video frame associated with an XR application at the UE, encode the render portion of the video frame, and perform real-time protocol (RTP) packetization on the encoded portion of the video frame, thereby producing one or more PDU sets that make up a periodic burst transmission. Accordingly, the varying frame generation times at the AS 215 may be based on a render time (e.g., render time may be scene dependent), an encoder time (e.g., encoder time based on complexity of a frame), and an RTP packetization time.

As such, because XR communications may include jitter, which may degrade communications and increase power consumption at the UE, techniques may be desired to minimize the performance degradation of the jitter window, thereby enabling the configuration of an eCDRX cycle at the UE 115, the configuration of SPS and CG scheduling at the UE 115, or both.

According to the techniques described herein, a network entity 105, such as an AS, may buffer (e.g., delay) a portion of a periodic burst transmission (e.g., one or more PDU sets) for a threshold percentage of a jitter window in order to mitigate the effects of the jitter during communications, thereby enabling the UE 115 to reduce the quantity of time operating in the connected mode and resulting in power savings at the UE 115. For example, the AS may generate one or more PDU sets of a first periodic burst transmission, where the first periodic burst transmission may be associated with a first delivery deadline at the UE 115 during a jitter window. Accordingly, in some examples, the AS may buffer at least a portion of the one or more PDU sets for a first duration of the jitter window, where the first duration corresponds to a threshold percentage (e.g., 90%, 99%, 100%) of the jitter window. That is, the AS may delay at least a portion of the one or more PDU sets (e.g., one or more PDU sets generated prior to a threshold time) such that the arrival time of the first periodic burst transmission may be deterministic.

In response to buffering the portion of the one or more PDU sets, the AS may output the one or more PDU sets to the UPF, where the UPF may forward the one or more PDU sets to the RAN. In such examples, the RAN may configure the UE 115 with a DRXD cycle that includes an on-duration and an offset that is based on the jitter window and the buffering of the first periodic transmission. In such examples, the DRX cycle may include a relatively smaller on-duration, thereby enabling the UE 115 to save power.

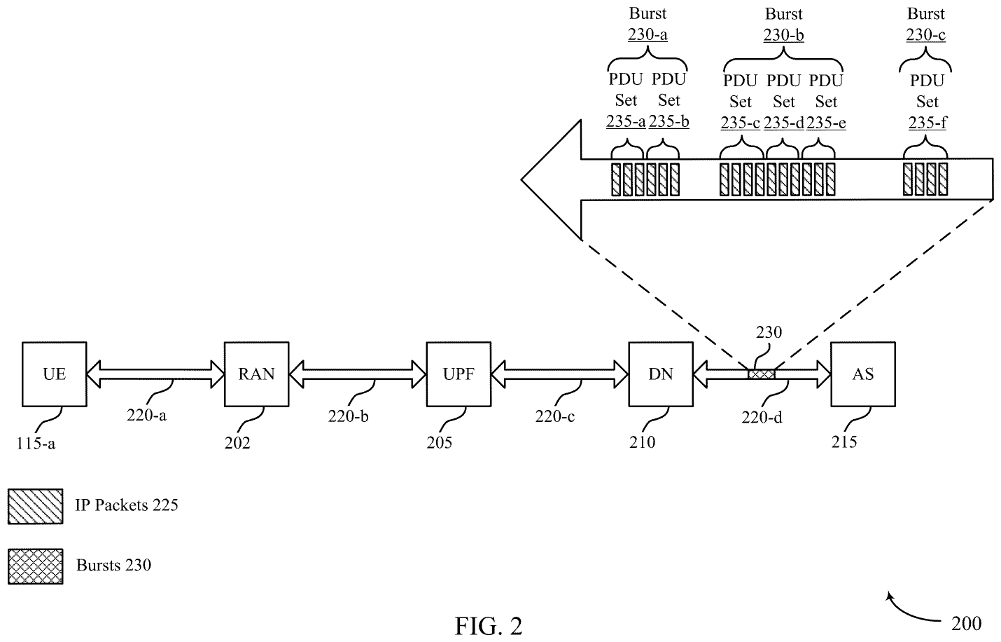

FIG. 2 shows an example of a wireless communications system 200 that supports mitigating jitter in communications in accordance with one or more aspects of the present disclosure. Aspects of the wireless communications system 200 may implement, or be implemented by, aspects of wireless communications system 100. For example, the wireless communications system 200 may include a UE 115-a, which may be an example of a UE 115, as described with reference to FIG. 1. The wireless communications system 200 may also include a RAN 202, which may be an example of a network entity 105, described with reference to FIG. 1. The wireless communications system 200 may also include a UPF 205, a data network (DN) 210, and an AS 215, which may be examples of corresponding entities operating in a core network 130, as described with reference to FIG. 1. The techniques described in the context of the wireless communications system 200 may enable the AS 215, the UPF 205, or the RAN 202 to delay one or more bursts 230 (e.g., periodic burst transmissions), thereby mitigating the effects of jitter during XR communications.

In some examples, the AS 215 may communicate, to the UE 115-a, data associated with an XR application operating (e.g., running) at the UE 115-a. In such examples, the XR application may consume (e.g., transmit or receive) data in one or more PDU sets 235 of a burst 230 (e.g., periodic burst transmission) rather than in singular IP packets 225. That is, instead of transmitting singular IP packets 225 to the UE 115-a, the AS 215 may transmit one or more PDU sets 235, where a PDU set 235 includes a set of IP packets 225 (e.g., one or more IP packets 225) and represents a unit of information associated with the XR application at the UE 115-a (e.g., a slice or portion of a video frame, which can be forward error correction (FEC) protected). As described herein, a PDU set 235 may be referred to as an application data unit (ADU). A burst 230 (e.g., a periodic burst transmission) may include a set of PDU sets 235 (e.g., one or more PDU sets 235), where each of the PDU sets 235 may be associated with a same delivery deadline at the UE 115-a. In such examples, the burst 230 may carry all slices (e.g., portions) of an XR video frame or one or more slices of the XR video frame. In some examples, the XR application operating at the UE 115-a may determine the transport layer parameters for the PDU sets 235. Further, in 5G XR communications, the UE 115-a and the AS 215 may utilize an enhanced RTP to indicate the metadata associated with each PDU set 235.

In some examples, each of the PDU sets 235 may be associated with a QoS parameter, such as PSDB, where the PSDB may be used in place of a PDB. The PSDB may define an upper bound for a delay that a PDU set 235 may experience for the transfer between the UE 115-a and the UPF 205 (e.g., the N6 termination point at the UPF 205). In downlink communications, the PSDB may be counted (e.g., started or valid) when the PDU sets 235 arrive at the UPF 205. As such, each PDU set 235 within a burst 230 may be associated with a same PSDB or a respective PSDB.

As an illustrative example, the AS 215 may output, via a communication link 220-d, one or more bursts 230 to the DN 210, such as a burst 230-a, a burst 230-b, and a burst 230-c. The burst 230-a may include a PDU set 235-a and PDU set 235-b, where both the PDU set 235-a and the PDU set 235-b have a same delivery deadline at the UE 115-a. The burst 230-b may include a PDU set 235-c, a PDU set 235-d, and a PDU set 235-e, where the PDU set 235-c, the PDU set 235-d, and the PDU set 235-e have a same delivery deadline at the UE 115-a. Similarly, the burst 230-c may include the PDU set 235-f. As described herein, each PDU set 235 may include one or more IP packets 225.

Accordingly, in response to receiving the bursts 230 from the AS 215, the DN 210 may forward the bursts 230 to the UPF via the communication link 220-c, which may be referred to as an N6 interface. The UPF 205 may receive the bursts 230 from the DN 210 and proceed to forward the bursts 230 to the RAN 202 via the communication link 220-b, which may be referred to as an N3 interface. In response to receiving the bursts 230, the RAN may forward the bursts to the UE 115-a over the communication link 220-a, which may be referred to as a Uu interface. In this way, the UE 115-a may obtain the data associated with the XR application.

In some examples, the communication flow between the AS 215 and the UE 115-a may be associated with a jitter window, where the jitter window may be a statistical calculation of arrival times of one or more bursts 230 over the communication flow. Accordingly, the jitter window of the communication flow (e.g., BAT) may be associated with a minimum arrival time of a burst 230 (e.g., the earliest time a burst 230 may arrive at the UE 115-a over the communication flow), an average arrival time of a burst 230 (e.g., when the average periodic burst may arrive at the UE 115 over the communication flow), and a maximum arrival time of a burst 230 (e.g., the latest time a burst 230 may arrive at the UE 115 over the communication flow).

The source of the jitter window (e.g., cause of the jitter in the BAT of the bursts 230) may be based on jitter associated with generation of the bursts 230 at the AS 215 (e.g., rendering, encoding, and packetizing of a video frame), jitter of packet delivery over the communication link 220-c (e.g., N6 interface), jitter of packet delivery over the communication link 220-b (e.g., N3 interface), or a combination thereof. In such examples, jitter incurred during generation of the bursts 230 may be relatively larger (e.g., the major source of jitter) than the jitter incurred over the communication link 220-c and the communication link 220-b. In some examples, such as in edge computing, the jitter incurred over the communication link 220-c (e.g., N6 interface) may be negligible due to the bursts 230 being delivered over a private network. Alternatively, for non-edge computing, the jitter incurred over the communication link 220-c (e.g., N6 interface) may not be negligible due to the bursts 230 being delivered over a public network.

In some examples, the jitter incurred over the communication link 220-b (e.g., N3 interface) may be relatively small, as compared to the jitter incurred over the communication link 220-c, due to the burst 230 being delivered over a private network. In such examples, however, if the jitter window spans a relatively large time period, the UE 115-a may operate in a connected mode (e.g., on mode) for an increased amount of time, thereby reducing power savings at the UE. Thus, techniques may be desired to reduce the effects of jitter during communications.

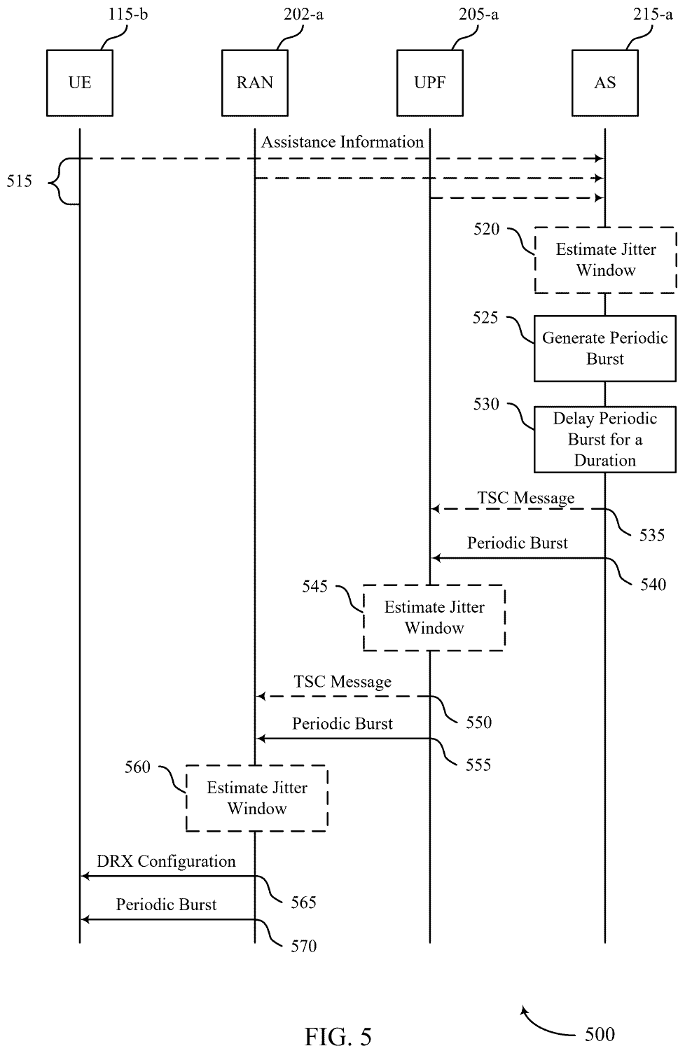

According to techniques described herein, the AS 215, the UPF 205, or the RAN 202 may delay delivering at least a portion of the bursts 230 (e.g., delay a portion of the one or more PDU sets 235) for a first duration, where the first duration correspond to a threshold percentage of the jitter window. In one example, in response to generating the burst 230-a, the AS 215 may delay the transmission of the burst 230-a for a duration, where the duration corresponds to a threshold percentage of the jitter window. Such techniques by the AS 215 may be further described herein with reference to FIG. 5.

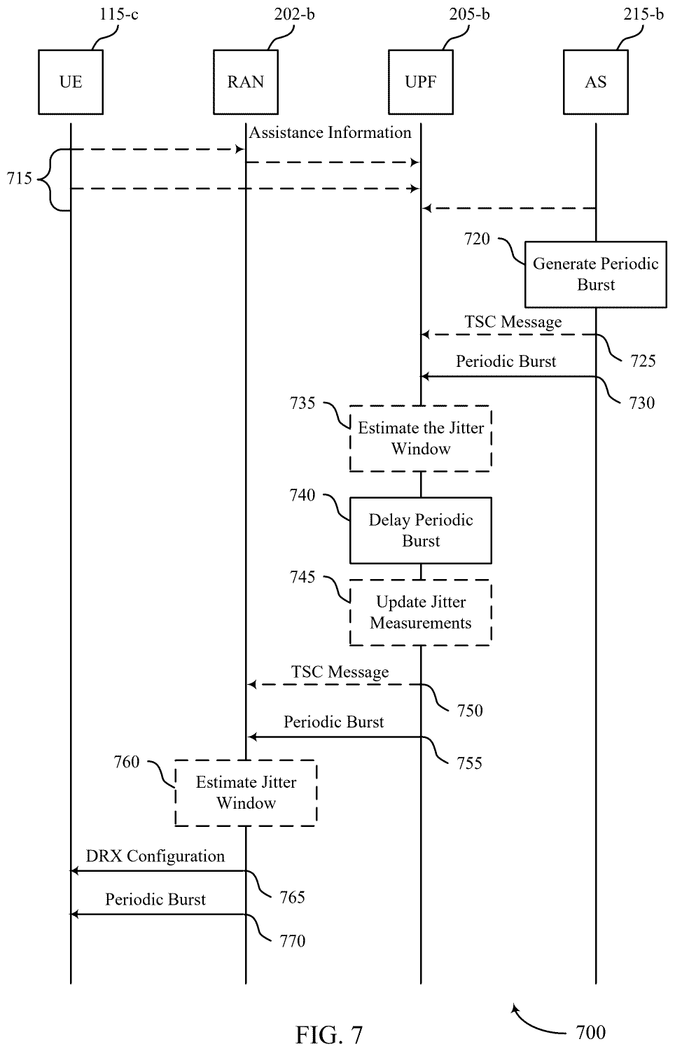

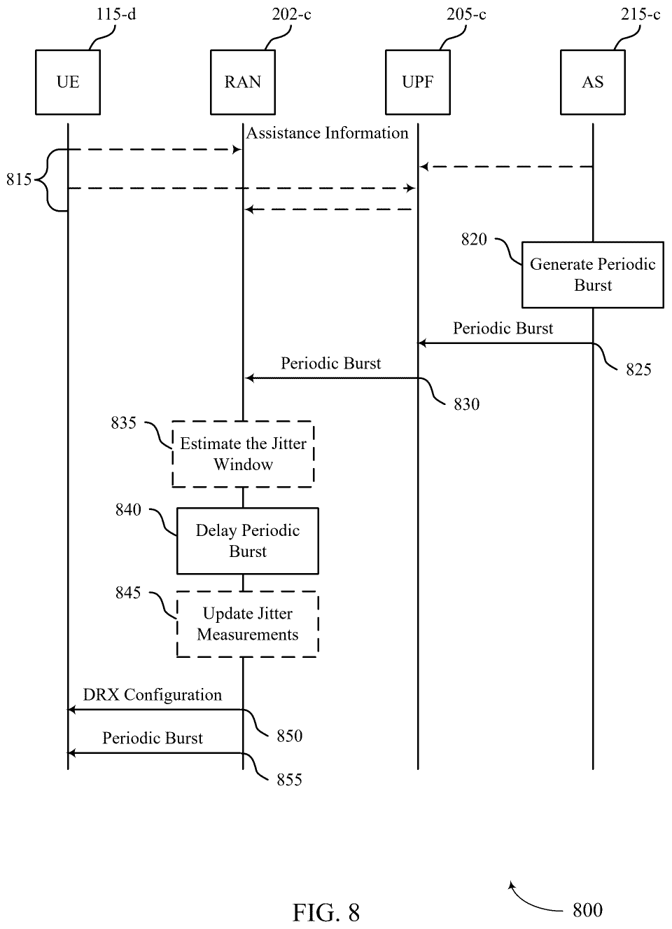

In another example, in response to receiving the burst 230-a from the DN 210, the UPF 205 may delay the output of the burst 230-a for a duration, where the duration corresponds to a threshold percentage of the jitter window. Such techniques by the UPF 205 may be further described herein with reference to FIG. 7. In another example, in response to receiving the burst 230-a from the UPF 205, the RAN 202 may delay the output of the burst 230-a for a duration, where the duration corresponds to a threshold percentage of the jitter window. Such techniques by the UPF 205 may be further described herein with reference to FIG. 8.

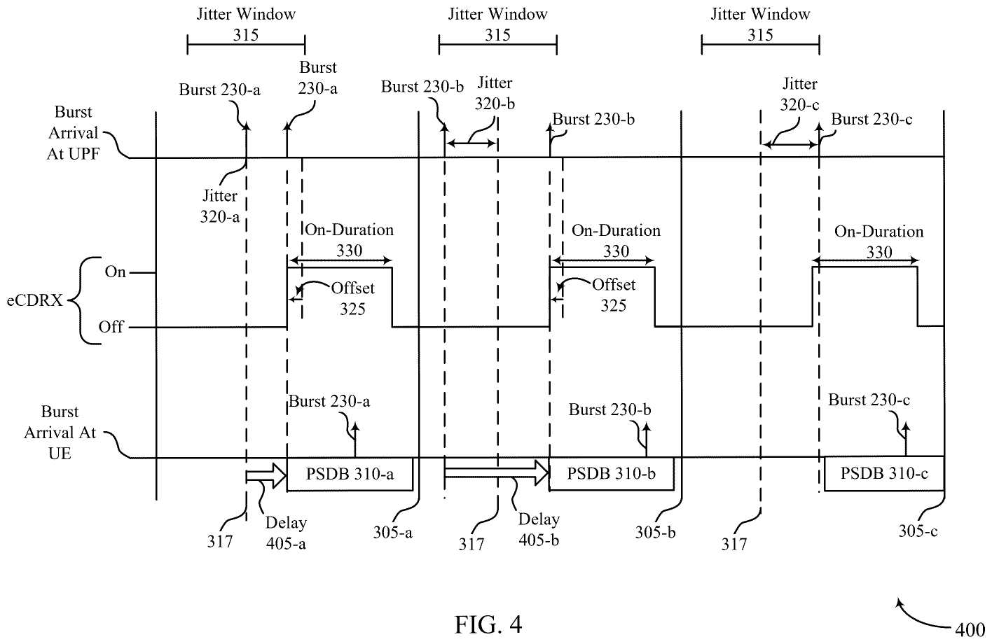

Accordingly, by delaying the bursts 230, the arrival time of the bursts 230 may become deterministic, such that the RAN 202 may be able to configure an eCDRX cycle based on the deterministic arrival time of the bursts 230, such that an on-duration of the UE 115-a may be reduced, thereby saving power at the UE 115-a. Such techniques to configure the eCDRX cycle may be further described herein with reference to FIG. 4-8. Additionally, by having the arrival time of the bursts 230 be deterministic (e.g., known), the RAN 202 may allocate a single radio resource according to the arrival time of the bursts 230, thereby reducing the quantity of resources allocated to cover the entire jitter window.

In some examples, although described in the context of 5G communications systems, the techniques described herein may be applied to other communication technologies, such as Wi-Fi target wake time (TWT) communications. Additionally, the techniques described herein may be implemented by RAN intelligence (e.g., RAN Intelligent Controller (RIC)), where the RIC may identify a jitter window of a communication flow and initiate the techniques described herein according to the identified jitter window and other parameters. Further, the techniques described herein may be applied to multiple users (e.g., one or more UEs 115), where each UE 115 may have a relatively small jitter range based on buffering of the respective bursts 230. Accordingly, the relatively small jitter window may reduce the chance of transmission periods overlapping for the UEs 115.

Additionally, although described in the context of downlink communications, the techniques described herein may be applied to various other communication flows and types, such as applied to uplink bursts 230 originated from the UE 115, applied for CG communications, applied for UE assistance information (UAI) uplink traffic patterns, applied for cross-layer application programming interface (API) to provide the related information, or a combination thereof.

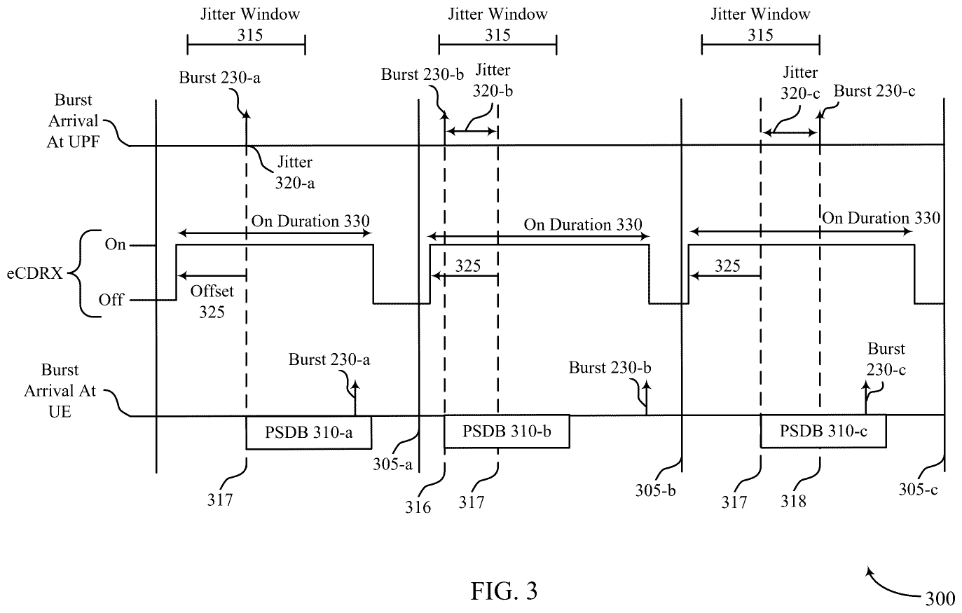

FIG. 3 shows an example of a timing diagram 300 that supports mitigating jitter in communications in accordance with one or more aspects of the present disclosure. Aspects of the timing diagram 300 may implement, or be implemented by, aspects of the wireless communications system 100 and the wireless communications system 200. For example, a UE 115, a RAN 202, a UPF 205, a DN 210, or an AS 215, which may be examples of corresponding devices described with reference to FIGS. 1 and 2, may communicate according to the timing diagram 300.

The timing diagram 300 may include a timeline corresponding to the arrival times of the bursts 230 at the UPF 205, where the burst arrival times at the UPF 205 may be shown relative to the eCDRX cycle of the UE 115 and relative to the burst arrival times at the UE 115. The timing diagram may include an eCDRX cycle at the UE 115. The eCDRX cycle may include an off duration, where the UE 115 is operating in an idle mode, and an on-duration 330, where the UE 115 is operating in an active mode. The on and off durations of the eCDRX cycle may be shown relative to the burst arrival time at the UPF 205 and the burst arrival times at the UE 115. The timing diagram 300 may also include a timeline corresponding to the arrival times of the bursts 230 at the UE 115, where the burst arrival times at the UE 115 may be shown relative to the eCDRX cycle at the UE 115 and the burst arrival times at the UPF 205.

In the example of the timing diagram 300, a UE 115 may receive bursts 230 from a RAN 202, where the bursts 230 originated from an AS 215. In such examples, each burst 230 may be associated with a respective delivery deadline 305. For example, a burst 230-a may be associated with a delivery deadline 305-a, a burst 230-b may be associated with a delivery deadline 305-b, and a burst 230-c may be associated with a delivery deadline 305-c. The delivery deadline 305 may represent a time at which an application (e.g., an XR application) at the UE 115 consumes the data included in the respective bursts 230, otherwise the data included in the bursts 230 becomes invalid. That is, the delivery deadlines 305 may represent the upper-bound time by when a burst 230 should be delivered to meet a playtime time or display refresh time (e.g., delivery deadline=playout time−processing time) at the UE 115. In such examples, the delivery deadlines 305 may be associated with a same application at the UE 115, and be periodic since playout time may be periodic (e.g., the display refresh time of the application may be periodic).

Additionally, as described herein, each burst 230 may be associated with a PSDB 310, for example, the burst 230-a may be associated with a PSDB 310-a, the burst 230-b may be associated with a PSDB 310-b, and the burst 230-c may be associated with a PSDB 310-c. As illustrated, and described herein, each of the PSDBs 310 may start relative to the arrival times of the bursts 230 at the UPF 205. That is, the PSDBs 310 may start (e.g., begin or take effect) in response to the arrival of the bursts 230 at the UPF 205.

The communication flow between the UE 115 and the AS 215 may be associated with jitter 320, which may cause a jitter window 315. The jitter window 315 may span a time period that includes an average arrival time 317 (e.g., average arrival time of the bursts 230 at the UPF 205), a minimum arrival time 316 (e.g., a minimum arrival time of the bursts 230 at the UPF 205) from the average arrival time 317, and an average a maximum arrival time 318 (e.g., a maximum arrival time of the bursts 230 at the UPF 205) from the average arrival time 317 (one or more of reference numbers 316, 317, and 318 may not be shown in FIG. 3 in connection with bursts 230-a, 230-b, and 230-c, depending on context). For example, the jitter windows 315 may be a statistical calculation of the arrival times of one or more bursts 230 over a communication flow between the UE 115 and the AS 215. In such examples, the jitter window 315 associated with each burst 230 may be relative to the generation time of the bursts 230 at the AS 215, such that the minimum arrival time 316, the average arrival time 317, and the maximum arrival time 318 associated with a respective burst 230 may be identified relative to the start time of the generation of the respective burst 230 at the AS 215.

In some examples, the bursts 230 may not be affected by jitter 320, such that the bursts 230 may arrive at the UPF at the average arrival time 317 and subsequently arrive at the UE 115 prior to the delivery deadline 305 and within the PSDB 310. For example, the burst 230-a may arrive at the UPF 205 at a time corresponding to the average arrival time 317, where the jitter 320-a may be equal to 0. As such, the UPF 205 may transmit the burst 230-a to the RAN 202, where the RAN 202 may forward the burst 230-a to the UE 115. Accordingly, the UE 115 may receive the burst 230-a within the PSDB 310-a and prior to the delivery deadline 305-a.

In some other examples, however, due to the jitter 320 associated with the bursts 230 and to meet the delivery deadlines 305 and PSDBs 310, the RAN 202 may configure the UE 115 with an eCDRX configuration where an on-duration 330 of the eCDRX configuration may be longer than an off duration of the eCDRX configuration (referred to herein in some instances as an “aggressive eCDRX configuration”). For example, the RAN 202 may set an offset 325 of the eCDRX configuration to be prior to the minimum arrival time 316 and set the on-duration 330 to be greater than the jitter windows 315 associated with the bursts 230, such that the on-duration 330 extends from before the minimum arrival times 316 to after the maximum arrival times 318 of the jitter windows 315. As such, with the extended eCDRX configuration, the UE 115 may be awake in order to receive a burst 230-b arriving prior to the average arrival time 317 (e.g., an early burst 230 associated with jitter 320-b) or receive a burst 230-c arriving after the average arrival time 317 (e.g., a later burst 230 associated with jitter 320-c). Accordingly, due to the aggressive eCDRX configuration, the UE 115 may wake up relatively earlier and stay in an active connected mode for longer, thereby reducing power savings at the UE 115.

To reduce the impact of the aggressive eCDRX cycle, the techniques described herein may enable the AS 215, the UPF 205, or the RAN 202 to delay the bursts 230 for a threshold percentage of the jitter window 315. Such techniques may be further described herein with reference to FIGS. 4-8.

FIG. 4 shows an example of a timing diagram 400 that supports mitigating jitter in communications in accordance with one or more aspects of the present disclosure. Aspects of the timing diagram 400 may implement, or be implemented by, aspects of the wireless communications system 100, the wireless communications system 200, and the timing diagram 300. For example, a UE 115, a RAN 202, a UPF 205, a DN 210, or an AS 215, which may be examples of corresponding devices described with reference to FIGS. 1 and 2, may communicate according to the timing diagram 400. The timing diagram 400 may include delivery deadlines 305 (e.g., a delivery deadline 305-a, a delivery deadline 305-b, and a delivery deadline 305-c) and PSDBs 310 (e.g., a PSDB 310-a, a PSDB 310-b, and PSDB 310-c), which may be examples of the delivery deadlines 305 and PSDBs 310, as described herein with reference to FIG. 3. The timing diagram 400 may also include a jitter window 315, a minimum arrival time 316, an average arrival time 317, and a maximum arrival time 318, which may be examples of corresponding times as described herein with reference to FIG. 3.

The timing diagram 400 may include a timeline corresponding to the arrival times of the bursts 230 at the UPF 205, where the burst arrival times at the UPF 205 may be shown relative to the eCDRX cycle of the UE 115 and relative to the burst arrival times at the UE 115. The timing diagram may include an eCDRX cycle at the UE 115. The eCDRX cycle may include an off duration, where the UE 115 is operating in an idle mode, and an on-duration 330, where the UE 115 is operating in an active mode. The on and off durations of the eCDRX cycle may be shown relative to the burst arrival time at the UPF 205 and the burst arrival times at the UE 115. The timing diagram 300 may also include a timeline corresponding to the arrival times of the bursts 230 at the UE 115, where the burst arrival times at the UE 115 may be shown relative to the eCDRX cycle at the UE 115 and the burst arrival times at the UPF 205.

In accordance with the techniques described herein, because there is no impact to the XR application at the UE 115 if the burst 230 arrives by the delivery deadlines 305 and because the PSDB 310 starts when the bursts 230 arrive at the UPF 205, the bursts 230 may be buffered by a delay 405, such that the arrival times of the bursts 230 at the UE 115 are deterministic and prior to the delivery deadlines 305. This may enable the RAN 202 to configure a less aggressive eCDRX cycle where the on-duration 330 of the eCDRX configuration does not have to be longer than an off duration of the eCDRX configuration, resulting in power savings at the UE 115. That is, because the arrival time of the bursts 230 at the UE 115 are deterministic, the RAN 202 may set the offset 325 based on the jitter window 315 (e.g., BAT), a remaining jitter (not shown), a margin (not shown), a jitter associated with the N6 interface, or a combination thereof. Additionally, the RAN 202 may set the on-duration 330 of the eCDRX cycle to be a relatively smaller value (e.g., less than the jitter window 315), for example, by setting the on-duration 330 based on the remaining jitter, the margin, the jitter associated with the N6 interface, or a combination thereof.

As an illustrative example, the burst 230-a may be buffered by a delay 405-a (e.g., a duration), where the delay 405-a may correspond to a first threshold percentage of the jitter window 315 (e.g., 90% of the jitter window). Accordingly, a remaining jitter may be equal to the difference between the jitter window 315 and the delay 405-a (e.g., 10% of the jitter window). As such, the on-duration 330 and offset 325 may be set accordingly, such that the UE 115 may experience power savings.

As another illustrative example, the burst 230-b may be buffered by a delay 405-b (e.g., a duration), where the delay 405-b corresponds to a second threshold percentage of the jitter window 315 (e.g., 99% of the jitter window). Accordingly, a remaining jitter may be equal to the difference between the jitter window 315 and the delay 405-b (e.g., 1% of the jitter window). As such, the on-duration 330 and offset 325 may be set accordingly, such that the UE 115 may experience power savings.

As another illustrative example, the burst 230-c may be buffered for a duration that corresponds to a third threshold percentage of the jitter window 315 (e.g., greater than 99% of the jitter window or 100% of the jitter window). Accordingly, a remaining jitter may be equal to less than 1% of the jitter window. That is, there may be no remaining jitter or negligible remaining jitter. As such, the on-duration 330 and offset 325 may be set accordingly, such that the UE 115 may experience power savings.

In such examples, the bursts 230 may be delayed by an AS 215, a UPF 205, or a RAN 202 in accordance with the techniques described herein with reference to FIGS. 5-8. Additionally, although three illustrative examples of the delay 405-a are described, it should be understood that the bursts 230 may be delayed by any threshold percentage of the jitter window that results in a deterministic arrival time of the bursts 230, thereby enabling the RAN 202 to set the offset 325 and the on-duration 330 for the eCDRX cycle accordingly.

In this way, by buffering the bursts 230 for the delays 405 (e.g., durations corresponding to a threshold percentage of the jitter window 315), the UE 115 may receive the bursts 230 prior to the delivery deadlines 305 and within the PSDBs 310, while also experiencing power savings. For example, because the RAN 202 may configure the on-duration 330 and the offset 325 according to jitter window 315, delay 405, remaining jitter, margin, or a combination thereof, the on-duration 330 of the UE 115 may be reduced (relative to the on-duration 330 of FIG. 3), thereby saving power at the UE 115.

FIG. 5 shows an example of a process flow 500 that supports mitigating jitter in communications in accordance with one or more aspects of the present disclosure. Aspects of the process flow 500 may implement, or be implemented by, aspects of the wireless communications system 100, the wireless communications system 200, the timing diagram 300, and the timing diagram 400 as described herein with reference to FIGS. 1-3. For example, the process flow 500 may include a UE 115-b, a RAN 202-a, a UPF 205-a, and an AS 215-a which may be examples of corresponding devices described with reference to FIGS. 1-3. In the following description of the process flow 500, the operations may be performed in a different order than the order shown. Specific operations also may be left out of the process flow 500, or other operations may be added to the process flow 500. Further, although some operations or signaling may be shown to occur at different times for discussion purposes, these operations may actually occur at the same time. The techniques described in the context of the process flow 500 may enable the AS 215-a to delay a first periodic burst transmission, thereby mitigating the effects of jitter in the wireless communications system.

At 515, the AS 215-a may obtain control signaling that includes assistance information associated with the UE 115-b, where the assistance information may indicate a delivery deadline (e.g., the delivery deadline 305) associated with a first periodic burst transmission (e.g., bursts 230), a periodicity associated with the first periodic burst transmission, a jitter window (e.g., jitter window 315) associated with the first periodic burst transmission, a duration for which the first periodic burst transmission is to be delayed, a threshold percentage of the jitter window for which the first periodic burst transmission is to be delayed, or a combination thereof.

Additionally, in some examples, the assistance information may indicate one or more jitter measurements, or parameters, associated with the communication flow between the UE 115-b and the AS 215-a (e.g., flow for BAT de-jitter buffering). Further, assistance information may indicate whether the communication flow between the UE 115-b and the AS 215-a supports delaying (e.g., buffering) of the first periodic burst transmission (e.g., BAT de-jittering), whether to enable or disable the delaying of the first periodic burst transmission, or any combination thereof.

In such examples, the UE 115-b may provide the assistance information directly to the AS 215-a. Alternatively, the UE 115-b may provide the assistance information to the RAN 202-a, where the RAN 202-a may provide the assistance information to the AS 215-a directly, or via the UPF 205-a. In some other examples, the UE 115-b may provide the assistance information to the UPF 205-a, where the UPF 205-a may forward the assistance information to the AS 215-a. In some examples, the RAN 202-a, the UPF 205-a, or both, may generate the assistance information, and subsequently provide the assistance information to the AS 215-a. Alternatively, in some examples, the AS 215-a may have an indication of such parameters (e.g., delivery deadline, periodicity, jitter window, duration, or the like) based on monitoring the communication flow between the UE 115-b and the AS 215-a. That is, the AS 215-a may have an indication of whether a flow (e.g., a flow associated with jitter) will be periodically consumed by a UE 115-b (e.g., a client) regardless of jitter, whether the communication flow supports delaying of the first periodic burst transmission, or both.

At 520, the AS 215-a may estimate the jitter window associated with the communication flow (e.g., estimate or measure the jitter window for the communication flow between the UE 115-b and the AS 215-a.).

In some examples, the AS 215-a may utilize a static jitter estimation algorithm to estimate the jitter window, where the AS 215-a may estimate the jitter window associated with the first periodic burst transmission according to previous statistical information (e.g., jitter windows) of the communication flow. For example, the AS 215-a may store one or more previously measured jitter windows associated with previous periodic burst transmissions (e.g., a second jitter window associated with a send periodic burst transmission) in a reference table, where the previously measured jitter windows may be categorized, or stored, according to one or more operating conditions that were present during the transmission of the previous periodic burst transmissions.

Such operating conditions may include a workload of the AS 215-a, a data rate of the previous periodic burst transmissions, a periodicity associated with the previous periodic burst transmissions, an XR configuration of the AS 215-a, an XR configuration of the XR application at the UE 115-b, or a combination thereof. As such, the AS 215-a may utilize the stored jitter windows, measured from previous periodic burst transmissions, to estimate the jitter window associated with the first periodic burst transmission. Additionally, in such examples, the AS 215-a may update the jitter window measurements after each periodic burst transmission (e.g., based on the traffic over the communication flow). That is, in response to estimating the jitter window associated with the first periodic burst transmission, the AS 215-a may store the estimated jitter window in the reference table according to the operating conditions associated with the first periodic burst transmission.

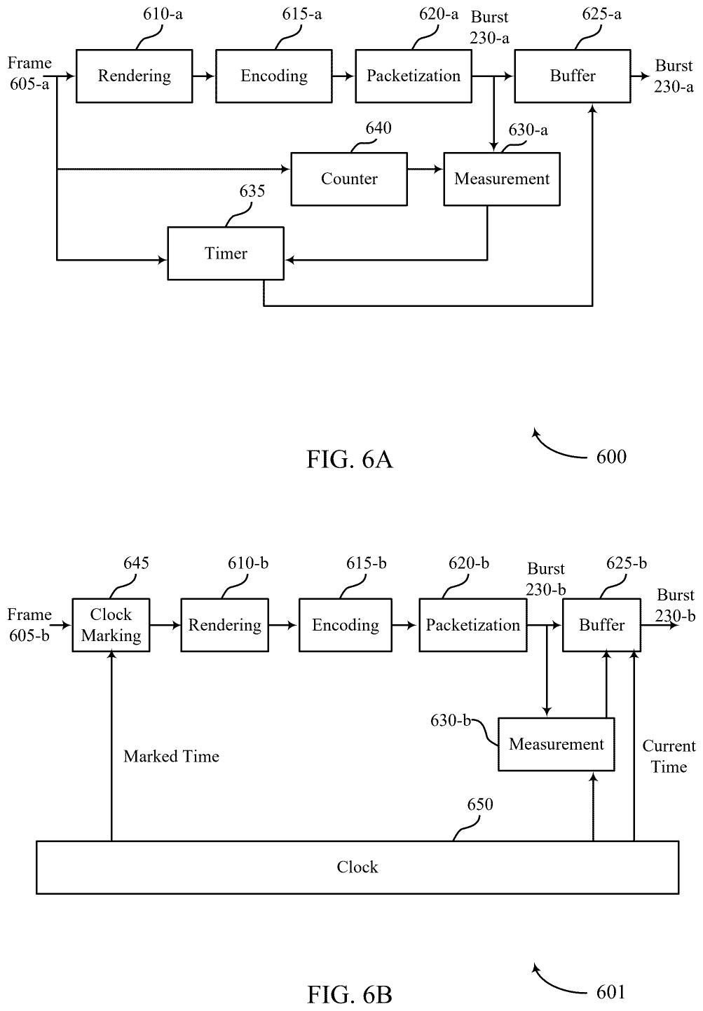

In some other examples, the AS 215-a may utilize a dynamic jitter estimation algorithm to estimate the jitter window, where the AS 215-a may estimate the jitter window dynamically during the generation of the first periodic burst transmission (e.g., estimate the jitter window during ongoing frame generation). For example, for the first periodic burst generation (e.g., frame generation), the AS 215-a may have an indication as to when the first periodic burst transmission is generated (e.g., knows a start time of generation). As such, based on the start time of the generation, the AS 215-a may measure a duration associated with generating the first periodic burst transmission. Accordingly, after the first periodic burst transmission (e.g., frame) is generated, the AS 215-a may estimate the jitter window associated with the first periodic burst transmission based on the measured duration (e.g., frame generation time). Techniques to dynamically estimate the jitter window may be further described herein with reference to FIGS. 6A and 6B.

In such examples, if the operating conditions during frame generation change (e.g., the data rate of the periodic burst transmissions, periodicity of the periodic burst transmissions, workload of the AS 215-a, XR configurations, or the like), the AS 215-a may restart the jitter window measurements. Additionally, in such examples, the AS 215-a may update the jitter window measurements after each periodic burst transmission (e.g., based on the traffic over the communication flow). That is, in response to estimating the jitter window associated with the first periodic burst transmission using the dynamic jitter estimation algorithm, the AS 215-a may store the estimated jitter window in the reference table according to the operating conditions associated with the first periodic burst transmission.

In some examples, the AS 215-a may utilize a hybrid jitter estimation algorithm to estimate the jitter window. For example, the AS 215-a may estimate the jitter window associated with the first periodic burst transmission using both previous jitter window measurements (e.g., previous statistical information) and using dynamic jitter window measurements during ongoing frame generation. For example, the AS 215-a may begin the jitter window estimation by using the previously stored jitter windows (e.g., jitter statistics). Accordingly, while the AS 215-a generates the one or more PDU sets of the first periodic burst transmission (e.g., XR frames), the AS 215-a may update the jitter window estimation. That is, after obtaining the duration associated with generating the first periodic burst transmission, the AS 215-a may utilize the measured duration and previously measured jitter durations to estimate the jitter window associated with the first periodic transmission. Additionally, in such examples, the AS 215-a may update the jitter window measurements after each periodic burst transmission (e.g., based on the traffic over the communication flow). That is, in response to estimating the jitter window associated with the first periodic burst transmission using the hybrid jitter estimation algorithm, the AS 215-a may store the estimated jitter window in the reference table according to the operating conditions associated with the first periodic burst transmission.

In some examples, the AS 215-a may ignore abnormal jitter window estimations. For example, if the AS 215-a estimates a jitter window that is greater than a threshold jitter window (e.g., spans a time period greater than a threshold), then the AS 215-a may ignore the estimated jitter window, and refrain from storing the estimated jitter window in the reference table.

At 525, in response to, or in conjunction with, estimating the jitter window, the AS 215-a may generate one or more PDU sets of the first periodic burst transmission, where the generation of the first periodic burst transmission may incur a major source of jitter of the communication flow, as described herein with reference to FIG. 2. For example, to generate the first periodic burst transmission, the AS 215-a may render at least a portion of a video frame associated with an XR application at the UE 115-b. In response to the rendering, the AS 215-a may encode the portion of the video frame and proceed to packetize the portion of the video frame to obtain the one or more PDU sets of the first periodic burst transmission. In such examples, the source of the jitter may be incurred during the rendering, encoding, and packetization of the first periodic burst transmission.

At 530, the AS 215-a may buffer at least a portion of the one or more PDU sets of the first periodic burst transmission for the first duration of the jitter window, where the first duration may correspond to a threshold percentage of the jitter window, as described herein with reference to FIG. 4. For example, the AS 215-a may delay delivering at least a portion of the first periodic burst transmission (e.g., buffer at least a portion of the one or more PDU sets) to the UPF 205-a (e.g., 5GS) until a threshold of the maximum arrival time of the jitter window (e.g., a threshold percentage of the jitter window).

In some examples, the AS 215-a may delay the portion of the first periodic burst transmission (e.g., 90% of the one or more PDU sets) for a duration that corresponds to 90% of the jitter window, as described herein with reference to FIG. 4. In some other examples, the AS 215-a may delay the portion of the first periodic burst transmission (e.g., 99% of the one or more PDU sets) for a duration that corresponds to 99% of the jitter window, as described herein with reference to FIG. 4. In some other examples, the AS 215-a may delay all of the first periodic burst transmission (e.g., 100% or all of the one or more PDU sets) for a duration that corresponds to 100% of the jitter window, as described herein with reference to FIG. 4. In such examples, the portion of the first periodic burst transmission that is delayed may correspond to, or be based on, the delay duration (e.g., the threshold percentage of the jitter window). Techniques to delay the first periodic burst transmission may be further described herein with reference to FIGS. 6A and 6B.

At 535, in response to, prior to, or in conjunction with, delaying the first periodic burst transmission, the AS 215-a may output, to the UPF 205-a, a time sensitive communication (TSC) message including an indication of the jitter window. That is, the UPF 205-a may receive an indication of the jitter window (e.g., BAT) via the TSC message. In some examples, the AS 215-a may indicate, via the TSC message, that the delaying of the first periodic burst transmission is enabled (e.g., being performed), indicate the threshold percentage of the jitter window for which the first periodic burst transmission is delayed, or both. In some examples, the UPF 205-a may receive the TSC message from an application function (AF) that is associated with AS 215-a or the XR application of UE 115-b.

At 540, the AS 215-a may output the one or more PDU sets of the first periodic burst transmission after expiration of the first duration and prior to the first delivery deadline. For example, the AS 215-a may output the burst (e.g., one or more PDU sets) to the UPF 205-a via an N6 interface (e.g., interface between the AS 215-a and the UPF 205-a).

At 545, in response to receiving the first periodic burst transmission, the UPF 205-a may estimate the jitter window, a remaining jitter, or both. For example, the UPF 205-a may measure the jitter window (e.g., BAT) associated with the first periodic burst transmission according to the one of the static jitter estimation algorithm, the dynamic jitter estimation algorithm, or the hybrid jitter estimation algorithm as described herein. The UPF 205-a may perform such measurements based on the jitter window received via the TSC message at 435 or perform such measurements independent of the TSC message received at 435.

In some examples, the UPF 205-a may measure the remaining jitter of the jitter window. In one example, the UPF 205-a may add a jitter associated with the N6 interface (e.g., communication link 220-c between the AS 215-a and UPF 205-a) on top of the measured remaining jitter. For example, the UPF 205-a may identify the remaining jitter based on a difference between the jitter window and the threshold percentage of the jitter window (e.g., jitter window (100%)−threshold percentage of jitter window (x % tile jitter)). Based on identifying the remaining jitter, the UPF 205-a may calculate a jitter associated with the N6 interface between the UPF 205-a and the AS 215-a. Accordingly, the UPF 205-a may add the remaining jitter with the jitter associated with the N6 interface to obtain a remaining jitter that has the N6 jitter included.

In some other examples, the remaining jitter may be assumed to be a predetermined value. For example, because the jitter of the N6 interface between the UPF 205-a and the AS 215-a is consistent, the UPF 205-a may utilize a predetermined value as the jitter for the N6 interface, such that the remaining jitter may be calculated according to a predetermined value of the jitter associated with the N6 interface (e.g., jitter window (100%)−threshold percentage of jitter window (x %)+predetermined value (%)). In some other examples, the UPF 205-a may refrain from calculating the remaining (e.g., ignore the remaining jitter). For example, the UPF 205-a may not support the calculations of the remaining jitter.

At 550, in response to estimating the jitter window, the remaining jitter, or both, the UPF 205-a may transmit a TSC message indicating the estimated jitter window, the remaining jitter, or both to the RAN 202-a. In such examples, the UPF 205-a may transmit respective TSC messages to indicate the estimated jitter window and the remaining jitter. Alternatively, the UPF 205-a may include both the estimated remaining jitter and jitter window in a single TSC message. The TSC message may be an example of a TSC assistance information (TSCAI) message or a TSC assistance container (TSCAC) message. In some examples, the UPF 205-a may indicate, via the TSC message, that the delaying of the first periodic burst transmission is enabled (e.g., being performed), indicate the threshold percentage of the jitter window for which the first periodic burst transmission is delayed, or both.

At 555, in response to, prior to, or in conjunction with, transmitting the TSC message at 550, the UPF 205-a may output the first periodic burst transmission to the RAN 202-a. At 560, the RAN 202-a may estimate the jitter window, remaining jitter, or both (e.g., XR traffic patterns). In such examples, the RAN 202-a may utilize the static, dynamic, or hybrid jitter estimation algorithms or use artificial intelligence or machine learning models to identify the jitter statistics. Such operations at 560 may be performed prior to or after reception of the periodic burst at 555.

At 565, the RAN 202-a may output control signaling indicating one or more parameters corresponding to a DRX cycle (e.g., eCDRX configuration) associated with the UE 115-b based on the jitter window, the remaining jitter, or both, where the jitter window, the remaining jitter, or both are received via the TSC message from the UPF 205-a at 550 or estimated by the RAN 202-a at 560. The one or more parameters of the DRX cycle may include an offset (e.g., offset 325) and an on-duration (e.g., on-duration 330). In such examples, the RAN 202-a may set the offset based on the jitter window, the remaining jitter, a jitter associated with communications between the UPF 205-a and the AS 215-a (e.g., N6 interface jitter), a first margin, or a combination thereof (e.g., offset=jitter window−remaining jitter−N6 interface jitter−margin). The RAN 202-a may set the on-duration based on the remaining jitter, the jitter associated with the communications between the UPF 205-a and the AS 215-a, a second margin, or a combination thereof (e.g., on-duration=remaining jitter+N6 interface jitter+margin).

At 570, the RAN 202-a may output the one or more PDU sets of the first periodic burst transmission prior to the first delivery deadline. For example, the RAN 202-a may output the first periodic burst transmission to the UE 115-b, such that the one or more PDU sets of the first periodic burst transmission are delivered by the respective PSDBs and prior to the delivery deadline.

FIG. 6A and FIG. 6B show examples of a buffering diagram 600 and a buffering diagram 601, respectively, that support mitigating jitter in communications in accordance with one or more aspects of the present disclosure. One or more aspects of the buffering diagram 600 and buffering diagram 601 may be implemented by a network device, such as an AS 215, a UPF 205, or a RAN 202 as described with reference to FIGS. 1-5. The buffering diagram 600 may include rendering component 610-a, an encoding component 615-a, a packetization component 620-a, a buffer component 625-a, a measurement component 630-a, a timer 635, and a counter 640. The buffering diagram 601 may include a rendering component 610-b, an encoding component 615-b, a packetization component 620-b, a buffer component 625-b, a measurement component 630-b, a clock marking component 645, and a clock 650. The techniques described in the context of the buffering diagram 600 and the buffering diagram 601 may enable the network device (e.g., AS 215, the UPF 205, or the RAN 202) to delay a burst 230 (e.g., a first periodic burst transmission).

With reference to the buffering diagram 600 of FIG. 6A, the network device may implement a local timer-based implementation for buffering the burst 230-a. For example, when an event (e.g., generation of the burst 230-a from the frame 605-a) starts, the network device (e.g., AS 215) may start the timer 635, which has been set to an initial value (e.g., a duration corresponding to the threshold percentage of a jitter window). Additionally, the network device may initiate the counter 640, which may start from zero. To generate the burst 230-a, the network device (e.g., AS 215) may begin to render the frame 605-a using the rendering component 610-a, encode the rendered frame 605-a using the encoding component 615-a, and packetize the encoded frame 605-a using the packetization component 620-a to obtain the burst 230-a.

As such, during the rendering, encoding, and packetization, the timer 635 (e.g., duration corresponding to a threshold percentage of the jitter window) may decrease while the counter 640 may increase. In response to the completion of at least a portion of the burst 230-a, the buffer component 625-a may delay (e.g., hold) the generated portions of the burst 230-a (e.g., generated frame) until the timer 535 expires (e.g., until expiration of the duration). When the timer 635 expires, the buffer component 625-a of the network device may release the portion of the burst 230-a, such that the network device may output the burst 230-a (e.g., delivers the frame to UPF 205). In this way, the network device may buffer at least a portion of the burst 230-a for a threshold percentage of the jitter window.

In such examples, the network device may utilize the value of the counter 640 to update the statistics regarding the jitter window using the measurement component 630-a. For example, because the generation of the burst 230-a (e.g., rendering, encoding, and packetizing) causes the majority of the jitter for the burst 230-a, the network device may update the statistics regarding the jitter window according to the generation time of the burst 230-a (e.g., the value of the counter 640). The network device may update the minimum arrival time (e.g., minimum arrival time 316) of the jitter window, the average arrival time of the jitter window (e.g., the average arrival time 317), the maximum arrival time (e.g., the maximum arrival time 318) of the jitter window, the mean of the jitter window, a variance of the jitter window, or a combination thereof, based on the value of the counter 640 (e.g., the duration associated with generating the burst 230-a). Accordingly, the measurement component 630-a may update the initial value of the timer 635 (e.g., the duration corresponding to the threshold percentage of the jitter window) according to the updated jitter statistics.

Such techniques may be utilized by the RAN 202 and the UPF 205, where the rendering component 610-a, the encoding component 615-a, and the packetization component 620-a may be skipped or replaced by reception of the one or more PDU sets of the burst 230-a. For example, in response to reception of the burst 230-a, the UPF 205 or the RAN 202 may initiate the timer 635 that is set to an initial value, and buffer the burst 230-a until expiration of the timer 635 using the buffer component 625-a.

With reference to the buffering diagram 601, the network device (e.g., AS 215) may implement a global timer-based implementation for buffering the burst 230-b. For example, when an event starts (e.g., generation of the burst 230-b from the frame 605-b), the network device may mark (e.g., identify) a time associated with the start of the rendering of the frame 605-b, where such a time may be referred to as a marked time. To generate the burst 230-b, the network device (e.g., AS 215) may begin to render the frame 605-b using the rendering component 610-b, encode the rendered frame 605-b using the encoding component 615-b, and packetize the encoded frame 605-b using the packetization component 620-b to obtain the burst 230-b.

In response to the completion of at least a portion of the burst 230-b, the buffer component 625-a may delay (e.g., hold) the generated portions of the burst 230-b (e.g., generated frame) until a duration (e.g., the duration corresponding to a threshold percentage of the jitter window) has expired. For example, in response to completion of the generated burst 230-b, the clock 650 may indicate to the buffer component 625-b a current time (e.g., a time at which the burst 230-b was fully generated). Accordingly, the buffer component 625-b may calculate a frame generation time (e.g., frame generation duration) associated with the burst 230-b based on the marked time and the current time (e.g., frame generation time=current time−marked time). Accordingly, if the duration associated with the frame generation time (e.g., marked time+frame generation time) is below the duration corresponding to the threshold percentage of the jitter window, the buffer component 625-b may delay the burst 230-b. Alternatively, if the duration associated with the frame generation time (e.g., marked time+frame generation time) is greater than, or equal to, the duration corresponding to the threshold percentage of the jitter window, the buffer component 625-b may release the burst 230-b, such that the network device may transmit the burst 230-b (e.g., to the UPF 205).

In such examples, the network device may utilize the frame generation time to update the statistics regarding the jitter window using the measurement component 630-b. For example, because the generation of the burst 230-b (e.g., rendering, encoding, and packetizing) causes the majority of the jitter for the burst 230-b, the network device may update the statistics regarding the jitter window according to the frame generation time of the burst 230-b. The network device may update the minimum arrival time (e.g., minimum arrival time 316) of the jitter window, the average arrival time of the jitter window (e.g., the average arrival time 317), the maximum arrival time (e.g., the maximum arrival time 318) of the jitter window, the mean of the jitter window, a variance of the jitter window, or a combination thereof based on the frame generation time of the burst 230-b. Accordingly, the measurement component 630-b may update the duration corresponding to the threshold percentage of the jitter window according to the updated jitter statistics.

Such techniques may be utilized by the RAN 202 and the UPF 205, where the rendering component 610-b, the encoding component 615-b, and the packetization component 620-b may be skipped or replaced by reception of the one or more PDU sets of the burst 230-b. For example, in response to reception of the burst 230-b, the UPF 205 or the RAN 202 may identify the marked time using the clock marking component 645, and buffer the burst 230-b until expiration the duration corresponding to the threshold percentage of the jitter window using the buffer component 625-b.

Although, the buffering diagram 600 and the buffering diagram 601 may be used delay the bursts 230, it should be understood that any methodology by which the AS 215, UPF 205, or RAN 202 use to buffer the bursts 230 or restrict the jitter window may be applicable to the techniques described herein.

FIG. 7 shows an example of a process flow 700 that supports mitigating jitter in communications in accordance with one or more aspects of the present disclosure. Aspects of the process flow 700 may implement, or be implemented by, aspects of the wireless communications system 100, the wireless communications system 200, the timing diagram 300, the timing diagram 400, the process flow 500, the buffering diagram 600, and the buffering diagram 601 as described herein with reference to FIGS. 1-6B. For example, the process flow 700 may include a UE 115-c, a RAN 202-b, a UPF 205-b, and an AS 215-b which may be examples of corresponding devices described with reference to FIGS. 1-6B. In the following description of the process flow 700, the operations may be performed in a different order than the order shown. Specific operations also may be left out of the process flow 700, or other operations may be added to the process flow 700. Further, although some operations or signaling may be shown to occur at different times for discussion purposes, these operations may actually occur at the same time. The techniques described in the context of the process flow 700 may enable the UPF 205-b to delay a first periodic burst transmission, thereby mitigating the effects of jitter in the wireless communications system.

At 715, the UPF 205-b may receive control signaling indicating assistance information, where the assistance information may indicate a delivery deadline (e.g., the delivery deadline 305) associated with the first periodic burst transmission (e.g., bursts 230), a periodicity associated with the first periodic burst transmission, a jitter window (e.g., jitter window 315) associated with the first periodic burst transmission, a duration for which the first periodic burst transmission is to be delayed, a threshold percentage of the jitter window for which the first periodic burst transmission is to be delayed, or a combination thereof. Additionally, in some examples, the assistance information may indicate one or more jitter measurements, or parameters, associated with the communication flow between the UE 115-c and the AS 215-b (e.g., flow for BAT de-jitter buffering). Further, assistance information may indicate whether the communication flow between the UE 115-c and the AS 215-b supports delaying (e.g., buffering) of the first periodic burst transmission (e.g., BAT de-jittering), whether to enable or disable the delaying of the first periodic burst transmission, or any combination thereof.

In some examples, the UPF 205-b may receive the assistance information from session management function (SFM), where the SMF may receive the assistance information from a policy control function (PCF). In such examples, the UPF 205-b may indicate the assistance information to the RAN 202-b (e.g., the PCF indicates assistance information to the SMF, where the SMF forwards assistance information to UPF 205-b, and the UPF 205-b indicates assistance information to RAN 202-b). In some other examples, the AS 215-b may provide the UPF 205-b with the assistance information via an AF or network exposure function (NEF) interface. For example, the AS 215-b may provide the assistance information to the PCF via the AF or NEF interface, where the PCF may forward the assistance information to the SMF, and the SMF may forward the assistance information to the UPF 205-b.

In some other examples, the UPF 205-b (e.g., 5GC) may receive the assistance information from the UE 115-c, directly, via the non-access stratum (NAS) protocol. In some other examples, the UPF 205-b may receive the assistance information from the UE 115-c via the RAN 202-b, where the RAN 202-b may receive the assistance information from the UE 115-c via RRC protocols (e.g., RRC messaging) and forward the assistance information to the UPF 205-b.

Alternatively, the UPF 205-b may have an indication of whether the communication flow between the AS 215-b and the UE 115-c will be periodically consumed by the UE 115-c regardless of jitter, where the SMF may manage the traffic characteristics (e.g., jitter statistics, buffering, periodicity, or the like) for the communication flow) and indicate such characteristics to the UPF 205-b.

At 720, in response to, after, or in conjunction with the operations at 715, the AS 215-b may generate the first periodic burst transmission. For example, the AS 215-b may generate one or more PDU sets of the first periodic burst transmission, where the generation of the first periodic burst transmission may incur a major source of jitter of the communication flow, as described herein with reference to FIG. 2. For example, to generate the first periodic burst transmission, the AS 215-b may render at least a portion of a video frame associated with an XR application at the UE 115-c. In response to rendering, the AS 215-b may encode the portion of the video frame and proceed to packetize the portion of the video frame to obtain the one or more PDU sets of the first periodic burst transmission. In such examples, the source of the jitter may be incurred during the rendering, encoding, and packetization of the first periodic burst transmission.

In some examples, at 725, the AS 215-b may output, to the UPF 205-b a TSC message including an indication of the jitter window associated with the first periodic burst transmission. That is, the UPF 205-b may receive an indication of the jitter window (e.g., BAT) via the TSC message. In some examples, the AS 215-a may indicate, via the TSC message, that the delaying of the first periodic burst transmission is enabled (e.g., being performed), indicate the threshold percentage of the jitter window for which the first periodic burst transmission is delayed, or both. In some examples, the UPF 205-b may receive the TSC message from an AF that is associated with AS 215-b or the XR application of UE 115-c.

At 730, the AS 215-b may output the first periodic burst transmission via an N6 interface, where the jitter associated with the N6 interface may be added to the jitter window, the remaining jitter, or both. In such examples, the UPF 205-b may identify the one or more PDU sets of the first periodic burst transmission according to metadata (e.g., RTP or static RTP (SRTP) headers) of the one or more PDU sets of the first periodic burst transmission. For example, each of the one or more PDU sets may have a same identifier in a header, such that the UPF 205-b has an indication that the one or more PDU sets are associated with a same periodic burst transmission.

At 735, the UPF 205-b may estimate the jitter window, the remaining jitter, or both associated with the first periodic burst transmission. In such examples, the UPF 205-b may estimate the jitter window in accordance with the techniques described herein with reference to the operations at 520 and 545 of FIG. 5. For example, the UPF 205-b may utilize a static jitter estimation algorithm, a dynamic jitter estimation algorithm, or a hybrid jitter estimation algorithm to estimate the jitter window. In such examples, the UPF 205-b may store the estimated jitter windows at a reference table of the UPF 205-b according to one or more operation conditions, as described herein with reference to FIG. 5. In some examples, the AS 215-a may ignore abnormal jitter window estimations. For example, if the UPF 205-b estimates a jitter window that is greater than a threshold jitter window (e.g., spans a time period greater than a threshold), then the UPF 205-b may ignore the estimated jitter window, and refrain from storing the estimated jitter window at the UPF 205-b.

At 740, the UPF 205-b may buffer at least a portion of the one or more PDU sets of the first periodic burst transmission for the first duration of the jitter window, where the first duration may correspond to a threshold percentage of the jitter window, as described herein with reference to FIG. 4. For example, the UPF 205-b may delay delivering at least a portion of the first periodic burst transmission (e.g., buffer at least a portion of the one or more PDU sets) to the RAN 202-b until a threshold of the maximum arrival time of the jitter window (e.g., a threshold percentage of the jitter window).

In some examples, the UPF 205-b may delay the portion of the first periodic burst transmission (e.g., 90% of the one or more PDU sets) for a duration that corresponds to 90% of the jitter window, as described herein with reference to FIG. 4. In some other examples, the UPF 205-b may delay the portion of the first periodic burst transmission (e.g., 99% of the one or more PDU sets) for a duration that corresponds to 99% of the jitter window, as described herein with reference to FIG. 4. In some other examples, the UPF 205-b may delay all of the first periodic burst transmission (e.g., 100% or all of the one or more PDU sets) for a duration that corresponds to 100% of the jitter window, as described herein with reference to FIG. 4. In such examples, the portion of the first periodic burst transmission that is delayed may correspond to, or be based on, the delay duration (e.g., the threshold percentage of the jitter window). The UPF 205-b may delay the first periodic burst transmission according to the techniques described herein with reference to FIGS. 6A and 6B.

At 745, in some examples, the UPF 205-b may update the jitter statistics stored at the UPF 205-b. For example, the UPF 205-b may store the jitter window estimated at 735 and update the jitter window associated with the communication flow accordingly. In some examples, the UPF 205-b may update the jitter statics according to the earliest arriving PDU, PDU set, or periodic burst transmission, according to the latest arriving PDU, PDU set, or periodic burst transmission, or both. For example, the UPF 205-b may identify the periodicity of the periodic bursts based on the average of the time intervals between two adjacent periodic burst transmission, identify the average arrival times (e.g., average arrival time 317 or nominal arrival time) based on the average of burst arrival times within the periodicity, and identify (e.g., measure) the jitter window based on the average arrival times. In this way, the UPF 205-b may maintain accurate jitter statistics (e.g., minimum arrival times 316, average arrival times 317, and a maximum arrival times 318) of the jitter windows over the communication flow.

At 750, the UPF 205-b may output a TSC message to the RAN 202-b, where the TSC message may include the jitter window (BAT), the remaining jitter, or both. The UPF 205-b may transmit the TSC message to the RAN 202-b according to the techniques described herein with reference to operations 550 of FIG. 5. For example, in response to estimating the jitter window, the remaining jitter, or both, the UPF 205-b may transmit a TSC message indicating the estimated jitter window, the remaining jitter, or both to the RAN 202-b. In such examples, the UPF 205-b may transmit respective TSC messages to indicate the estimated jitter window and the remaining jitter. Alternatively, the UPF 205-b may include both the estimated remaining jitter and jitter window in a single TSC message. The TSC message may be an example of a TSCAI message or a TSCAC message. In some examples, the UPF 205-b may indicate, via the TSC message, that the delaying of the first periodic burst transmission is enabled (e.g., being performed), indicate the threshold percentage of the jitter window for which the first periodic burst transmission is delayed, or both.

At 755, in response to, prior to, or in conjunction with, transmitting the TSC message at 750, the UPF 205-b may output the first periodic burst transmission to the RAN 202-b. As described herein, the one or more PDU sets of first periodic burst transmission may be associated a PDSB. Accordingly, an access network (AN) PSDB may be counted when the delayed periodic burst transmission arrives at the RAN 202-b, where the first periodic burst transmission may meet the associated delivery deadline. In such examples, the PSDB may be equal to the addition of a core network (CN) PSDB and the AN PSDB (e.g., PSDB=CN-PSDB+AN-PSDB). Further, the CN-PSDB may remain consistent regardless of the delay to the periodic burst transmission.

At 760, the RAN 202-b may estimate the jitter window, remaining jitter, or both (e.g., XR traffic patterns). In such examples, the RAN 202-b may utilize the static, dynamic, or hybrid jitter estimation algorithms or use artificial intelligence or machine learning models to identify the jitter statistics. Such operations at 760 may be performed prior to or after reception of the periodic burst at 755.

At 765, the RAN 202-b may output control signaling indicating one or more parameters corresponding to a DRX cycle (e.g., eCDRX configuration) associated with the UE 115-c based on the jitter window, the remaining jitter, or both, where the jitter window, the remaining jitter, or both are received via the TSC message from the UPF 205-a at 750, estimated by the RAN 202-b at 760, or both. The one or more parameters of the DRX cycle may include an offset (e.g., offset 325) and an on-duration (e.g., on-duration 330). In such examples, the RAN 202-b may set the offset based on the jitter window, the remaining jitter, a first margin, or a combination thereof (e.g., offset=jitter window−remaining jitter−margin). The RAN 202-b may set the on-duration based on the remaining jitter, a second margin, or a combination thereof (e.g., on-duration=remaining jitter+margin). In such examples, the remaining jitter may account for the jitter associated with the N6 interface, as the UPF 205-b may add the N6 jitter to the jitter window, remaining jitter, or both based on reception of the first periodic burst transmission.

At 770, the RAN 202-b may output the one or more PDU sets of the first periodic burst transmission prior to the first delivery deadline. For example, the RAN 202-b may output the first periodic burst transmission to the UE 115-c, such that the one or more PDU sets of the first periodic burst transmission are delivered by the respective PSDBs and prior to the delivery deadline.

FIG. 8 shows an example of a process flow 800 that supports mitigating jitter in communications in accordance with one or more aspects of the present disclosure. Aspects of the process flow 800 may implement, or be implemented by, aspects of the wireless communications system 100, the wireless communications system 200, the timing diagram 300, the timing diagram 400, the process flow 500, the buffering diagram 600, the buffering diagram 601, and the process flow 700 as described herein with reference to FIGS. 1-7. For example, the process flow 800 may include a UE 115-d, a RAN 202-c, a UPF 205-c, and an AS 215-c, which may be examples of corresponding devices described with reference to FIGS. 1-7.

In the following description of the process flow 800, the operations may be performed in a different order than the order shown. Specific operations also may be left out of the process flow 800, or other operations may be added to the process flow 800. Further, although some operations or signaling may be shown to occur at different times for discussion purposes, these operations may actually occur at the same time. The techniques described in the context of the process flow 800 may enable the RAN 202-c to delay a first periodic burst transmission, thereby mitigating the effects of jitter in the wireless communications system.

At 815, the RAN 202-c may receive control signaling indicating assistance information, where the assistance information may indicate a delivery deadline (e.g., the delivery deadline 305) associated with the first periodic burst transmission (e.g., bursts 230), a periodicity associated with the first periodic burst transmission, a jitter window (e.g., jitter window 315) associated with the first periodic burst transmission, a duration for which the first periodic burst transmission is to be delayed, a threshold percentage of the jitter window for which the first periodic burst transmission is to be delayed, or a combination thereof. Additionally, in some examples, the assistance information may indicate one or more jitter measurements, or parameters, associated with the communication flow between the UE 115-d and the AS 215-c (e.g., flow for BAT de-jitter buffering). Further, assistance information may indicate whether the communication flow between the UE 115-d and the AS 215-c supports delaying (e.g., buffering) of the first periodic burst transmission (e.g., BAT de-jittering), whether to enable or disable the delaying of the first periodic burst transmission, or any combination thereof.

In some examples, the RAN 202-c may receive the assistance information from the UPF 205-c, where the UPF 205-c may receive the assistance information from the SFM, and where the SMF may receive the assistance information from the PCF (e.g., the PCF indicates assistance information to the SMF, where the SMF forwards assistance information to UPF 205-c, and the UPF 205-c indicates assistance information to RAN 202-c). In some other examples, the AS 215-c may generate and provide the UPF 205-b with the assistance information via AF or NEF interface. For example, the AS 215-c may provide the assistance information to the PCF via the AF or NEF interface, where the PCF may forward the assistance information to the SMF, and the SMF may forward the assistance information to the UPF 205-c, where the UPF 205-c may forward the assistance information to the RAN 202-c.

In some other examples, the RAN 202-c may receive the assistance information from the UE 115-d, via, the UPF 205-c (e.g., 5GC). For example, the UE 115-d may provide the assistance information to the UPF 205-c via the NAS protocol, where the UPF 205-c may forward the assistance information to the RAN 202-c. In some other examples, the RAN 202-c may receive the assistance information from the UE 115-d via the RRC protocol (e.g., RRC messaging).

Alternatively, the RAN 202-c may have an indication of whether the communication flow between the AS 215-b and the UE 115-d will be periodically consumed by the UE 115-d regardless of jitter, where the SMF may manage the traffic characteristics (e.g., jitter statistics, buffering, periodicity, or the like) for the communication flow) and indicate such characteristics to the RAN 202-c.

At 820, in response to, after, or in conjunction with the operations at 815, the AS 215-c may generate the first periodic burst transmission. For example, the AS 215-c may generate one or more PDU sets of the first periodic burst transmission, where the generation of the first periodic burst transmission may incur a major source of jitter of the communication flow, as described herein with reference to FIG. 2. For example, to generate the first periodic burst transmission, the AS 215-c may render at least a portion of a video frame associated with an XR application at the UE 115-d. In response to rendering, the AS 215-c may encode the portion of the video frame and proceed to packetize the portion of the video frame to obtain the one or more PDU sets of the first periodic burst transmission. In such examples, the source of the jitter may be incurred during the rendering, encoding, and packetization of the first periodic burst transmission.

At 825, the AS 215-c may output the first periodic burst transmission via an N6 interface, where the jitter associated with the N6 interface may be added to the jitter window. At 830, the UPF 205-c may output the first periodic burst transmission to the RAN 202-c, where the jitter associated with the N3 interface may be added to the jitter window (e.g., the jitter associated with the communication link between the RAN 202-c and the UPF 205-c). In such examples, the RAN 202-c may identify the one or more PDU sets of the first periodic burst transmission according to metadata (e.g., RTP or SRTP headers) of the one or more PDU sets of the first periodic burst transmission. For example, each of the one or more PDU sets may have a same identifier in a header, such that the RAN 202-c has an indication that the one or more PDU sets are associated with a same periodic burst transmission.

As described herein, the one or more PDU sets of first periodic burst transmission may be associated a PDSB. Accordingly, an access network (AN) PSDB may be counted when the delayed periodic burst transmission arrives at the RAN 202-b, where the first periodic burst transmission may meet the associated delivery deadline. In such examples, the PSDB may be equal to the addition of a core network (CN) PSDB and the AN PSDB (e.g., PSDB=CN-PSDB+AN-PSDB). Further, the CN-PSDB may remain consistent regardless of the delay. Alternatively, the AN-PDSB (or AN PDB) may start to in response to the UE 115-d entering the on-duration of the DRX cycle.

At 835, the RAN 202-c may estimate the jitter window, the remaining jitter, or both associated with the first periodic burst transmission. In such examples, the RAN 202-c may estimate the jitter window in accordance with the techniques described herein with reference to the operations at 520, 545, or 560 of FIG. 5 or operations 735 or 760 of FIG. 7. For example, the RAN 202-c may utilize a static jitter estimation algorithm, a dynamic jitter estimation algorithm, or a hybrid jitter estimation algorithm to estimate the jitter window or use artificial intelligence or machine learning models to identify the jitter statistics to identify the jitter window (e.g., obtain the XR traffic characteristics). In such examples, the RAN 202-c may store the estimated jitter windows at a reference table of the RAN 202-c according to one or more operation conditions, as described herein with reference to FIG. 5. In some examples, the RAN 202-c may ignore abnormal jitter window estimations. For example, if the RAN 202-c estimates a jitter window that is greater than a threshold jitter window (e.g., spans a time period greater than a threshold), then the RAN 202-c may ignore the estimated jitter window, and refrain from storing the estimated jitter window at the RAN 202-c.

At 840, the RAN 202-c may buffer at least a portion of the one or more PDU sets of the first periodic burst transmission for the first duration of the jitter window, where the first duration may correspond to a threshold percentage of the jitter window, as described herein with reference to FIG. 4. For example, the RAN 202-c may delay delivering at least a portion of the first periodic burst transmission (e.g., buffer at least a portion of the one or more PDU sets) to the UE 115-d until a threshold of the maximum arrival time of the jitter window (e.g., a threshold percentage of the jitter window).

In some examples, the RAN 202-c may delay the portion of the first periodic burst transmission (e.g., 90% of the one or more PDU sets) for a duration that corresponds to 90% of the jitter window, as described herein with reference to FIG. 4. In some other examples, the RAN 202-c may delay the portion of the first periodic burst transmission (e.g., 99% of the one or more PDU sets) for a duration that corresponds to 99% of the jitter window, as described herein with reference to FIG. 4. In some other examples, the RAN 202-c may delay all of the first periodic burst transmission (e.g., 100% or all of the one or more PDU sets) for a duration that corresponds to 100% of the jitter window, as described herein with reference to FIG. 4. In such examples, the portion of the first periodic burst transmission that is delayed may correspond to, or be based on, the delay duration (e.g., the threshold percentage of the jitter window). The RAN 202-c may delay the first periodic burst transmission according to the techniques described herein with reference to FIGS. 6A and 6B.

At 845, in some examples, the RAN 202-c may update the jitter statistics stored at the RAN 202-c. For example, the RAN 202-c may store the jitter window estimated at 835 and update the jitter window associated with the communication flow accordingly. In some examples, the RAN 202-c may update the jitter statics according to the earliest arriving PDU, PDU set, or periodic burst transmission, according to the latest arriving PDU, PDU set, or periodic burst transmission, or both. For example, the RAN 202-c may identify the periodicity of the periodic bursts based on the average of the time intervals between two adjacent periodic burst transmission, identify the average arrival times (e.g., average arrival time 317 or nominal arrival time) based on the average of burst arrival times within the periodicity, and identify (e.g., measure) the jitter window based on the average arrival times. In this way, the RAN 202-c may maintain accurate jitter statistics (e.g., minimum arrival times 316, average arrival times 317, and a maximum arrival times 318) of the jitter windows over the communication flow.

At 850, the RAN 202-c may output control signaling indicating one or more parameters corresponding to a DRX cycle (e.g., eCDRX configuration) associated with the UE 115-d based on the jitter window, the remaining jitter, or both, where the jitter window, the remaining jitter, or both are estimated by the RAN 202-c at 835. The one or more parameters of the DRX cycle may include an offset (e.g., offset 325) and an on-duration (e.g., on-duration 330). In such examples, the RAN 202-c may set the offset based on the jitter window, the remaining jitter, a first margin, or a combination thereof (e.g., jitter window−remaining jitter−margin). The RAN 202-c may set the on-duration based on the remaining jitter, a second margin, or a both (e.g., remaining jitter+margin).

At 855, the RAN 202-c may output the one or more PDU sets of the first periodic burst transmission prior to the first delivery deadline. For example, the RAN 202-c may output the first periodic burst transmission to the UE 115-d, such that the one or more PDU sets of the first periodic burst transmission are delivered by the respective PSDBs and prior to the delivery deadline.

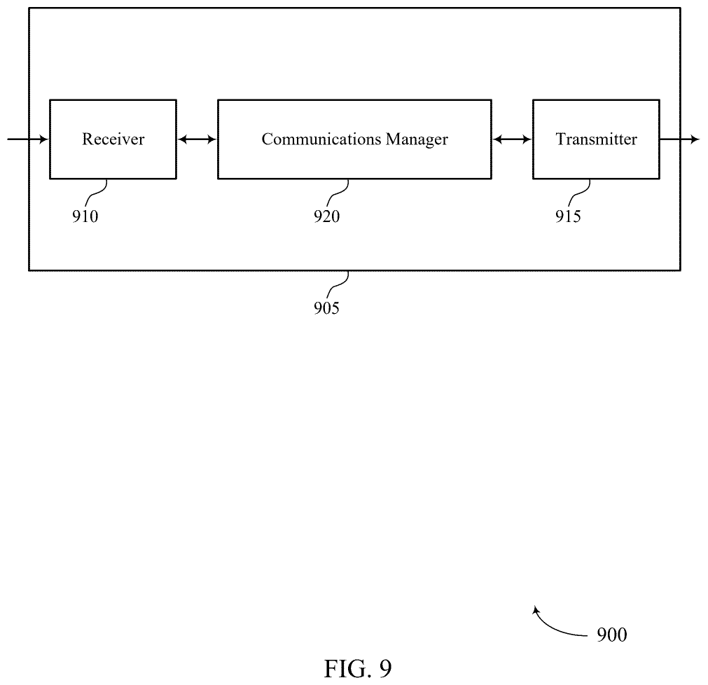

FIG. 9 shows a block diagram 900 of a device 905 that supports mitigating jitter in communications in accordance with one or more aspects of the present disclosure. The device 905 may be an example of aspects of a network entity 105, an AS, a UPF, or a RAN, as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of mitigating jitter in communications as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware or processor-readable instructions) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

In some examples, the device 905 may be an example of an AS, as described herein. In such examples, the communications manager 920 of the AS may support wireless communications in accordance with examples as disclosed herein. For example, the communications manager 920 is capable of, configured to, or operable to support a means for generating one or more PDU sets of a first periodic burst transmission, the first periodic burst transmission corresponding to a first delivery deadline at a UE during a jitter window, where the jitter window spans a time period prior to and after a first arrival time associated with the one or more PDU sets. The communications manager 920 is capable of, configured to, or operable to support a means for buffing at least a portion of the one or more PDU sets for a first duration of the jitter window, where the first duration corresponds to a threshold percentage of the jitter window. The communications manager 920 is capable of, configured to, or operable to support a means for outputting the one or more PDU sets based on expiration of the first duration and prior to the first delivery deadline.

Additionally, or alternatively, the device 905 may be an example of a RAN, as described herein. Accordingly, the communications manager 920 of the RAN may support wireless communications in accordance with examples as disclosed herein. For example, the communications manager 920 is capable of, configured to, or operable to support a means for obtaining a TSC message indicating a jitter window associated with one or more PDU sets of a first periodic burst transmission, where the jitter window spans a time period prior to and after a first arrival time associated with the one or more PDU sets, and where the one or more PDU sets of the first periodic burst transmission correspond to a first delivery deadline at a UE. The communications manager 920 is capable of, configured to, or operable to support a means for obtaining at least a portion of the one or more PDU sets of the first periodic burst transmission at a first time, where the first time corresponds to at least a threshold percentage of the jitter window. The communications manager 920 is capable of, configured to, or operable to support a means for outputting the one or more PDU sets prior to the first delivery deadline.

Additionally, or alternatively, the device 905 may be an example of a UPF, as described herein. Accordingly, the communications manager 920 of the UPF may support wireless communications in accordance with examples as disclosed herein. For example, the communications manager 920 is capable of, configured to, or operable to support a means for obtaining one or more PDU sets of a first periodic burst transmission, the first periodic burst corresponding to a first delivery deadline at a UE during a jitter window, where the jitter window spans a time period prior to and after a first arrival time associated with the one or more PDU sets. The communications manager 920 is capable of, configured to, or operable to support a means for buffing at least a portion of the one or more PDU sets for a first duration of the jitter window, where the first duration corresponds to a threshold percentage of the jitter window. The communications manager 920 is capable of, configured to, or operable to support a means for outputting the one or more PDU sets based on expiration of the first duration and prior to the first delivery deadline.

Additionally, or alternatively, the device 905 may be an example of a RAN. Accordingly, the communications manager 920 of the RAN may support wireless communications in accordance with examples as disclosed herein. For example, the communications manager 920 is capable of, configured to, or operable to support a means for obtaining one or more PDU sets of a first periodic burst transmission, the first periodic burst corresponding to a first delivery deadline at a UE during a jitter window, where the jitter window spans a time period prior to and after a first arrival time associated with the one or more PDU sets. The communications manager 920 is capable of, configured to, or operable to support a means for buffing at least a portion of the one or more PDU sets for a first duration of the jitter window, where the first duration corresponds to a threshold percentage of the jitter window. The communications manager 920 is capable of, configured to, or operable to support a means for outputting the one or more PDU sets based on expiration of the first duration and prior to the first delivery deadline.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for mitigating jitter in wireless communications systems, which may reduce power consumption at a UE.

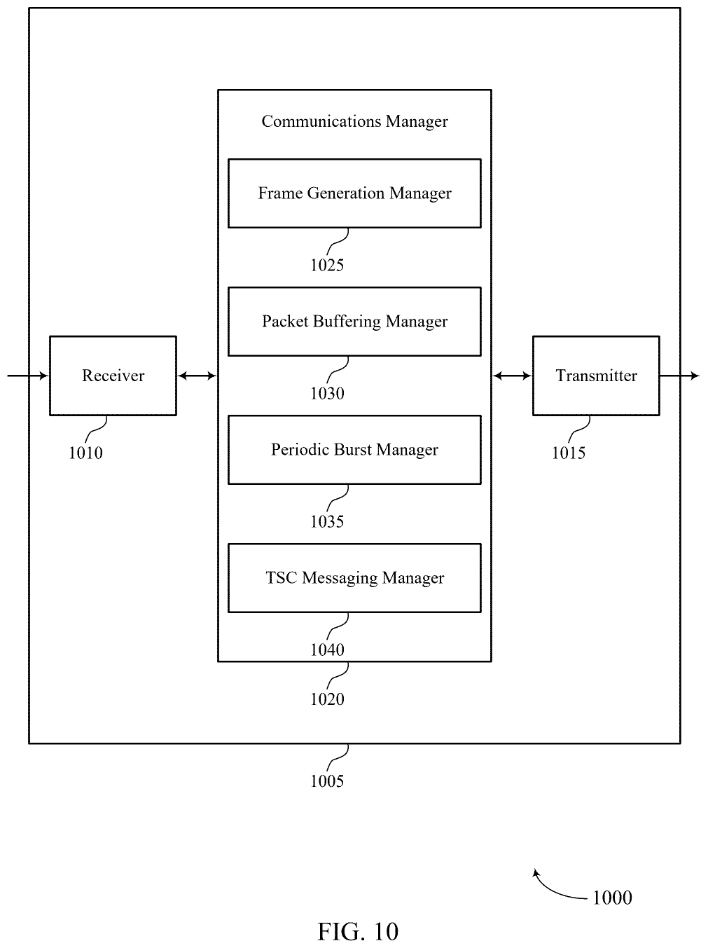

FIG. 10 shows a block diagram 1000 of a device 1005 that supports mitigating jitter in communications in accordance with one or more aspects of the present disclosure. The device 1005 may be an example of aspects of a device 905, an AS, a UPF, a RAN, or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of mitigating jitter in communications as described herein. For example, the communications manager 1020 may include a frame generation manager 1025, a packet buffering manager 1030, a periodic burst manager 1035, an TSC messaging manager 1040, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

In some examples, the device 905 may be an example of an AS, as described herein. Accordingly, the communications manager 1020 of the AS may support wireless communications in accordance with examples as disclosed herein. The frame generation manager 1025 is capable of, configured to, or operable to support a means for generating one or more PDU sets of a first periodic burst transmission, the first periodic burst transmission corresponding to a first delivery deadline at a UE during a jitter window, where the jitter window spans a time period prior to and after a first arrival time associated with the one or more PDU sets. The packet buffering manager 1030 is capable of, configured to, or operable to support a means for buffering at least a portion of the one or more PDU sets for a first duration of the jitter window, where the first duration corresponds to a threshold percentage of the jitter window. The periodic burst manager 1035 is capable of, configured to, or operable to support a means for outputting the one or more PDU sets based on expiration of the first duration and prior to the first delivery deadline.

Additionally, or alternatively, the device 905 may be an example of a RAN, as described herein. Accordingly, the communications manager 1020 of the RAN may support wireless communications in accordance with examples as disclosed herein. The TSC messaging manager 1040 is capable of, configured to, or operable to support a means for obtaining a TSC message indicating a jitter window associated with one or more PDU sets of a first periodic burst transmission, where the jitter window spans a time period prior to and after a first arrival time associated with the one or more PDU sets, and where the one or more PDU sets of the first periodic burst transmission correspond to a first delivery deadline at a UE. The periodic burst manager 1035 is capable of, configured to, or operable to support a means for obtaining at least a portion of the one or more PDU sets of the first periodic burst transmission at a first time, where the first time corresponds to at least a threshold percentage of the jitter window. The periodic burst manager 1035 is capable of, configured to, or operable to support a means for outputting the one or more PDU sets prior to the first delivery deadline.

Additionally, or alternatively, the device 905 may be an example of a UPF, as described herein. Accordingly, the communications manager 1020 may support wireless communications in accordance with examples as disclosed herein. The periodic burst manager 1035 is capable of, configured to, or operable to support a means for obtaining one or more PDU sets of a first periodic burst transmission, the first periodic burst corresponding to a first delivery deadline at a UE during a jitter window, where the jitter window spans a time period prior to and after a first arrival time associated with the one or more PDU sets. The packet buffering manager 1030 is capable of, configured to, or operable to support a means for buffering at least a portion of the one or more PDU sets for a first duration of the jitter window, where the first duration corresponds to a threshold percentage of the jitter window. The periodic burst manager 1035 is capable of, configured to, or operable to support a means for outputting the one or more PDU sets based on expiration of the first duration and prior to the first delivery deadline.

Additionally, or alternatively, may be an example of a RAN, as described herein. Accordingly, the communications manager 1020 of the RAN may support wireless communications in accordance with examples as disclosed herein. The periodic burst manager 1035 is capable of, configured to, or operable to support a means for obtaining one or more PDU sets of a first periodic burst transmission, the first periodic burst corresponding to a first delivery deadline at a UE during a jitter window, where the jitter window spans a time period prior to and after a first arrival time associated with the one or more PDU sets. The packet buffering manager 1030 is capable of, configured to, or operable to support a means for buffering at least a portion of the one or more PDU sets for a first duration of the jitter window, where the first duration corresponds to a threshold percentage of the jitter window. The periodic burst manager 1035 is capable of, configured to, or operable to support a means for outputting the one or more PDU sets based on expiration of the first duration and prior to the first delivery deadline.

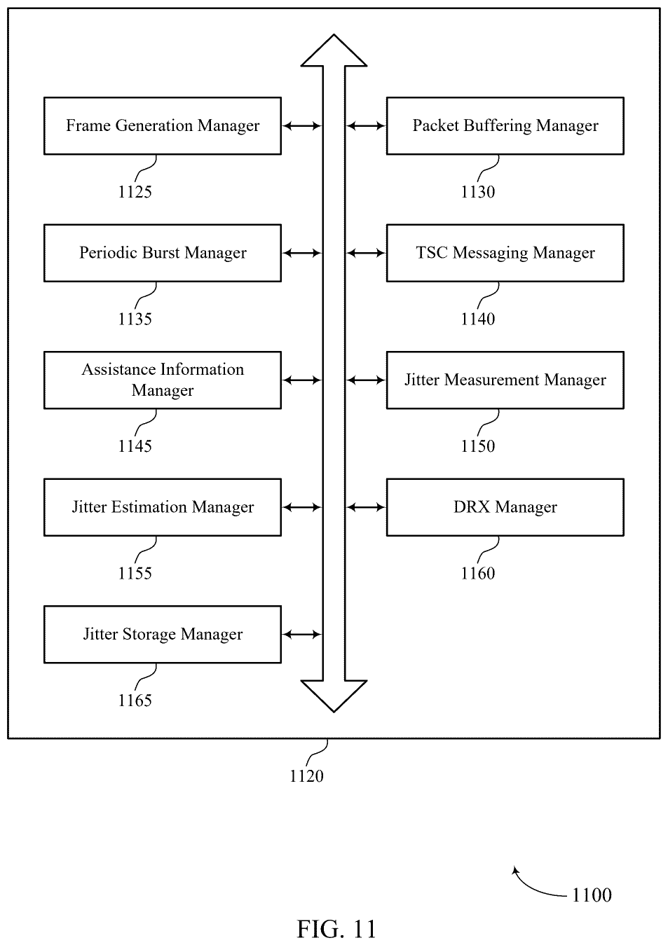

FIG. 11 shows a block diagram 1100 of a communications manager 1120 that supports mitigating jitter in communications in accordance with one or more aspects of the present disclosure. The communications manager 1120 may be an example of aspects of a communications manager 920, a communications manager 1020, or both, as described herein. The communications manager 1020 may be a component within an AS, a UPF, a RAN, or a network entity 105, as described herein. The communications manager 1120, or various components thereof, may be an example of means for performing various aspects of mitigating jitter in communications as described herein. For example, the communications manager 1120 may include a frame generation manager 1125, a packet buffering manager 1130, a periodic burst manager 1135, an TSC messaging manager 1140, an assistance information manager 1145, a jitter measurement manager 1150, a jitter estimation manager 1155, a DRX manager 1160, a jitter storage manager 1165, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

In some examples, the communications manager 1020 may be included within an AS, described herein. Accordingly, the communications manager 1120 of the AS may support wireless communications in accordance with examples as disclosed herein. The frame generation manager 1125 is capable of, configured to, or operable to support a means for generating one or more PDU sets of a first periodic burst transmission, the first periodic burst transmission corresponding to a first delivery deadline at a UE during a jitter window, where the jitter window spans a time period prior to and after a first arrival time associated with the one or more PDU sets. The packet buffering manager 1130 is capable of, configured to, or operable to support a means for buffering at least a portion of the one or more PDU sets for a first duration of the jitter window, where the first duration corresponds to a threshold percentage of the jitter window. The periodic burst manager 1135 is capable of, configured to, or operable to support a means for outputting the one or more PDU sets based on expiration of the first duration and prior to the first delivery deadline.

In some examples, the assistance information manager 1145 is capable of, configured to, or operable to support a means for obtaining control signaling including assistance information associated with the UE, the assistance information indicating the first delivery deadline, a periodicity associated with the first periodic burst transmission, the jitter window, the first duration, or any combination thereof, where buffering at least the portion of the one or more PDU sets is in accordance with the assistance information.

In some examples, the TSC messaging manager 1140 is capable of, configured to, or operable to support a means for outputting a TSC message including an indication of the jitter window based on generating the one or more PDU sets of the first periodic burst transmission.

In some examples, to support buffering the portion of the one or more PDU sets, the packet buffering manager 1130 is capable of, configured to, or operable to support a means for starting a timer in response to generating the one or more PDU sets, the timer being set to the first duration, where buffering the portion of the one or more PDU sets is based on starting the timer, and where outputting the one or more PDU sets is based on expiration of the timer.

In some examples, to support buffering the portion of the one or more PDU sets, the packet buffering manager 1130 is capable of, configured to, or operable to support a means for identifying a start time associated with the one or more PDU sets in response to generating the one or more PDU sets. In some examples, to support buffering the portion of the one or more PDU sets, the packet buffering manager 1130 is capable of, configured to, or operable to support a means for delaying the portion of the one or more PDU sets from the identified start time for the first duration, where outputting the one or more PDU sets is based on the expiration of the first duration.

In some examples, the jitter measurement manager 1150 is capable of, configured to, or operable to support a means for measuring a second jitter window associated with communication of a second periodic burst transmission, the second periodic burst transmission being prior to the first periodic burst transmission. In some examples, the jitter estimation manager 1155 is capable of, configured to, or operable to support a means for estimating the jitter window associated with the first periodic burst transmission based on the second jitter window.

In some examples, the jitter storage manager 1165 is capable of, configured to, or operable to support a means for storing the second jitter window based on measuring the second jitter window, where estimating the jitter window is based on the storing.

In some examples, the second jitter window is stored according to an XR configuration in a memory of the AS.

In some examples, the jitter measurement manager 1150 is capable of, configured to, or operable to support a means for measuring a respective jitter window associated with communication of one or more additional periodic burst transmissions, the one or more additional periodic burst transmissions being prior to the first periodic burst transmission and after the second periodic burst transmission. In some examples, the jitter estimation manager 1155 is capable of, configured to, or operable to support a means for updating the second jitter window stored in the AS based on measuring the respective jitter windows of each of the one or more additional periodic burst transmissions, where estimating the jitter window is based on updating the second jitter window.

In some examples, the second jitter window is based on an operating condition of the AS, a data rate of the second periodic burst transmission, a periodicity of the second periodic burst transmission, or a combination thereof.

In some examples, the jitter measurement manager 1150 is capable of, configured to, or operable to support a means for measuring a duration associated with generating the one or more PDU sets of the first periodic burst transmission. In some examples, the jitter estimation manager 1155 is capable of, configured to, or operable to support a means for estimating the jitter window based on the duration associated with generating the one or more PDU sets.

In some examples, estimating the jitter window using the duration is based on the duration being less than a threshold duration.

In some examples, the duration associated with generating the one or more PDU sets of the first periodic burst transmission is based on a data rate associated with the first periodic burst transmission, a periodicity of the first periodic burst transmission, or a combination thereof.

In some examples, the jitter measurement manager 1150 is capable of, configured to, or operable to support a means for identifying a second jitter window associated with a second periodic burst transmission, the second periodic burst transmission being prior to the first periodic burst transmission. In some examples, the jitter measurement manager 1150 is capable of, configured to, or operable to support a means for measuring a duration associated with generating the one or more PDU sets of the first periodic burst transmission. In some examples, the jitter estimation manager 1155 is capable of, configured to, or operable to support a means for estimating the jitter window based on the duration associated with generating the one or more PDU sets and the second jitter window associated with the second periodic burst transmission.

In some examples, to support generating the one or more PDU sets, the frame generation manager 1125 is capable of, configured to, or operable to support a means for rendering at least a portion of a video frame associated with XR communications. In some examples, to support generating the one or more PDU sets, the frame generation manager 1125 is capable of, configured to, or operable to support a means for encoding, based on the rendering, the portion of the video frame. In some examples, to support generating the one or more PDU sets, the frame generation manager 1125 is capable of, configured to, or operable to support a means for packetizing, based on the encoding, the portion of the video frame to obtain the one or more PDU sets of the first periodic burst transmission.

In some examples, the first arrival time is an average arrival time measured across one or more periodic burst transmissions, the one or more periodic burst transmissions occurring prior to the first periodic burst transmission.

Additionally, or alternatively, the communications manager 1020 may be included within a RAN, as described herein. Accordingly, the communications manager 1120 of the RAN may support wireless communications in accordance with examples as disclosed herein. The TSC messaging manager 1140 is capable of, configured to, or operable to support a means for obtaining a TSC message indicating a jitter window associated with one or more PDU sets of a first periodic burst transmission, where the jitter window spans a time period prior to and after a first arrival time associated with the one or more PDU sets, and where the one or more PDU sets of the first periodic burst transmission correspond to a first delivery deadline at a UE. In some examples, the periodic burst manager 1135 is capable of, configured to, or operable to support a means for obtaining at least a portion of the one or more PDU sets of the first periodic burst transmission at a first time, where the first time corresponds to at least a threshold percentage of the jitter window. In some examples, the periodic burst manager 1135 is capable of, configured to, or operable to support a means for outputting the one or more PDU sets prior to the first delivery deadline.

In some examples, the DRX manager 1160 is capable of, configured to, or operable to support a means for outputting control signaling indicating one or more parameters corresponding to a DRX associated with the UE based on the jitter window, where the one or more parameters include an offset and an on-duration.

In some examples, the offset is based on the jitter window, a remaining jitter, a jitter associated with communications between the RAN and a UPF, a first margin, or a combination thereof, the remaining jitter corresponding to a difference between the jitter window and the threshold percentage of the jitter window, and the on-duration is based on the remaining jitter, the jitter associated with the communications between an AS and the UPF, a second margin, or a combination thereof.

In some examples, the TSC message further indicates the remaining jitter, the jitter associated with the communications between an AS and the UPF, or both.

In some examples, the DRX manager 1160 is capable of, configured to, or operable to support a means for measuring the remaining jitter, the jitter associated with the communications between an AS and the UPF, or both, where the DRX is based on the measuring.

Additionally, or alternatively, the communications manager 1020 may be included as part of a UPF, as described herein. Accordingly, the communications manager 1120 of the UPF may support wireless communications in accordance with examples as disclosed herein. In some examples, the periodic burst manager 1135 is capable of, configured to, or operable to support a means for obtaining one or more PDU sets of a first periodic burst transmission, the first periodic burst corresponding to a first delivery deadline at a UE during a jitter window, where the jitter window spans a time period prior to and after a first arrival time associated with the one or more PDU sets. In some examples, the packet buffering manager 1130 is capable of, configured to, or operable to support a means for buffering at least a portion of the one or more PDU sets for a first duration of the jitter window, where the first duration corresponds to a threshold percentage of the jitter window. In some examples, the periodic burst manager 1135 is capable of, configured to, or operable to support a means for outputting the one or more PDU sets based on expiration of the first duration and prior to the first delivery deadline.

Additionally, or alternatively, the communications manager 1020 may be included as part of a RAN, as described herein. Accordingly, the communications manager 1120 of the RAN may support wireless communications in accordance with examples as disclosed herein. In some examples, the periodic burst manager 1135 is capable of, configured to, or operable to support a means for obtaining one or more PDU sets of a first periodic burst transmission, the first periodic burst corresponding to a first delivery deadline at a UE during a jitter window, where the jitter window spans a time period prior to and after a first arrival time associated with the one or more PDU sets. In some examples, the packet buffering manager 1130 is capable of, configured to, or operable to support a means for buffering at least a portion of the one or more PDU sets for a first duration of the jitter window, where the first duration corresponds to a threshold percentage of the jitter window. In some examples, the periodic burst manager 1135 is capable of, configured to, or operable to support a means for outputting the one or more PDU sets based on expiration of the first duration and prior to the first delivery deadline.

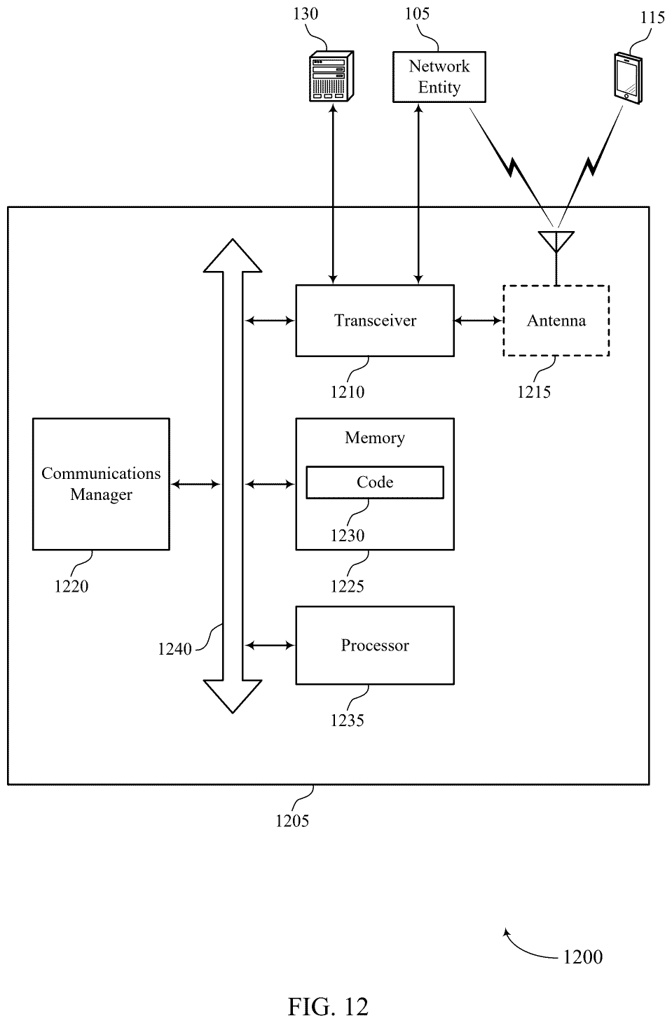

FIG. 12 shows a diagram of a system 1200 including a device 1205 that supports mitigating jitter in communications in accordance with one or more aspects of the present disclosure. The device 1205 may be an example of or include components of a device 905, a device 1005, an AS, a UPF, a RAN, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting mitigating jitter in communications). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225). In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network devices, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

In some examples, the device 1205 may be an example of an AS, as described herein. Accordingly, the communications manager 1220 of the AS may support wireless communications in accordance with examples as disclosed herein. For example, the communications manager 1220 is capable of, configured to, or operable to support a means for generating one or more PDU sets of a first periodic burst transmission, the first periodic burst transmission corresponding to a first delivery deadline at a UE during a jitter window, where the jitter window spans a time period prior to and after a first arrival time associated with the one or more PDU sets. The communications manager 1220 is capable of, configured to, or operable to support a means for buffing at least a portion of the one or more PDU sets for a first duration of the jitter window, where the first duration corresponds to a threshold percentage of the jitter window. The communications manager 1220 is capable of, configured to, or operable to support a means for outputting the one or more PDU sets based on expiration of the first duration and prior to the first delivery deadline.

Additionally, or alternatively, the device 1205 may be an example of a RAN, as described herein. Accordingly, the communications manager 1220 of the RAN may support wireless communications in accordance with examples as disclosed herein. For example, the communications manager 1220 is capable of, configured to, or operable to support a means for obtaining a TSC message indicating a jitter window associated with one or more PDU sets of a first periodic burst transmission, where the jitter window spans a time period prior to and after a first arrival time associated with the one or more PDU sets, and where the one or more PDU sets of the first periodic burst transmission correspond to a first delivery deadline at a UE. The communications manager 1220 is capable of, configured to, or operable to support a means for obtaining at least a portion of the one or more PDU sets of the first periodic burst transmission at a first time, where the first time corresponds to at least a threshold percentage of the jitter window. The communications manager 1220 is capable of, configured to, or operable to support a means for outputting the one or more PDU sets prior to the first delivery deadline.

Additionally, or alternatively, the device 1205 may be an example of a UPF, as described herein. Accordingly, the communications manager 1220 of the UPF may support wireless communications in accordance with examples as disclosed herein. For example, the communications manager 1220 is capable of, configured to, or operable to support a means for obtaining one or more PDU sets of a first periodic burst transmission, the first periodic burst corresponding to a first delivery deadline at a UE during a jitter window, where the jitter window spans a time period prior to and after a first arrival time associated with the one or more PDU sets. The communications manager 1220 is capable of, configured to, or operable to support a means for buffing at least a portion of the one or more PDU sets for a first duration of the jitter window, where the first duration corresponds to a threshold percentage of the jitter window. The communications manager 1220 is capable of, configured to, or operable to support a means for outputting the one or more PDU sets based on expiration of the first duration and prior to the first delivery deadline.

Additionally, or alternatively, the device 1205 may be an example of a RAN, as described herein. Accordingly, the communications manager 1220 of the RAN may support wireless communications in accordance with examples as disclosed herein. For example, the communications manager 1220 is capable of, configured to, or operable to support a means for obtaining one or more PDU sets of a first periodic burst transmission, the first periodic burst corresponding to a first delivery deadline at a UE during a jitter window, where the jitter window spans a time period prior to and after a first arrival time associated with the one or more PDU sets. The communications manager 1220 is capable of, configured to, or operable to support a means for buffing at least a portion of the one or more PDU sets for a first duration of the jitter window, where the first duration corresponds to a threshold percentage of the jitter window. The communications manager 1220 is capable of, configured to, or operable to support a means for outputting the one or more PDU sets based on expiration of the first duration and prior to the first delivery deadline.

By including or configuring the communications manager 1220 in accordance with examples as described herein, the device 1205 may support techniques for mitigating jitter in wireless communications, which may reduce power consumption at a UE.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of mitigating jitter in communications as described herein, or the at least one processor 1235 and the at least one memory 1225 may be otherwise configured to, individually or collectively, perform or support such operations.

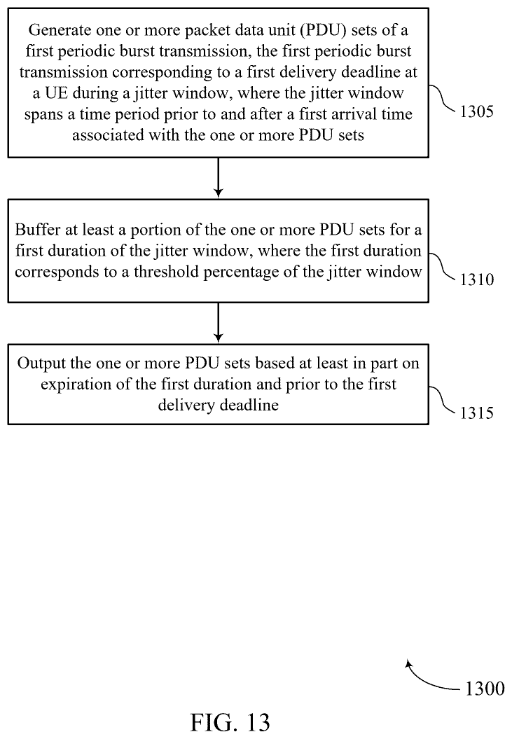

FIG. 13 shows a flowchart illustrating a method 1300 that supports mitigating jitter in communications in accordance with one or more aspects of the present disclosure. The operations of the method 1300 may be implemented by a network entity, such as an AS, or its components as described herein. For example, the operations of the method 1300 may be performed by a network entity as described with reference to FIGS. 1 through 12. In some examples, a network entity may execute a set of instructions to control the functional elements of the network entity to perform the described functions. Additionally, or alternatively, the network entity may perform aspects of the described functions using special-purpose hardware.

At 1305, the method may include generating one or more PDU sets (e.g., PDU sets 235 as described herein with reference to FIG. 2) of a first periodic burst transmission (e.g., bursts 230 as described herein with reference to FIG. 2), the first periodic burst transmission corresponding to a first delivery deadline (e.g., delivery deadlines 305 as described herein with reference to FIG. 3) at a UE during a jitter window, (e.g., the jitter window 315 as described herein with reference to FIG. 3), where the jitter window spans a time period prior to and after a first arrival time (e.g., the average arrival time 317 as described herein with reference to FIGS. 3 and 4) associated with the one or more PDU sets. The operations of 1305 may be performed in accordance with examples as disclosed herein, such as disclosed in operation 525 of FIG. 5. In some examples, aspects of the operations of 1305 may be performed by a frame generation manager 1125 as described with reference to FIG. 11.

At 1310, the method may include buffering at least a portion of the one or more PDU sets for a first duration of the jitter window, where the first duration corresponds to a threshold percentage of the jitter window. The operations of 1310 may be performed in accordance with examples as disclosed herein, such as disclosed in operation 530 of FIG. 5. In some examples, aspects of the operations of 1310 may be performed by a packet buffering manager 1130 as described with reference to FIG. 11.

At 1315, the method may include outputting the one or more PDU sets based on expiration of the first duration and prior to the first delivery deadline. The operations of 1315 may be performed in accordance with examples as disclosed herein, such as disclosed in operation 540 of FIG. 5. In some examples, aspects of the operations of 1315 may be performed by a periodic burst manager 1135 as described with reference to FIG. 11.

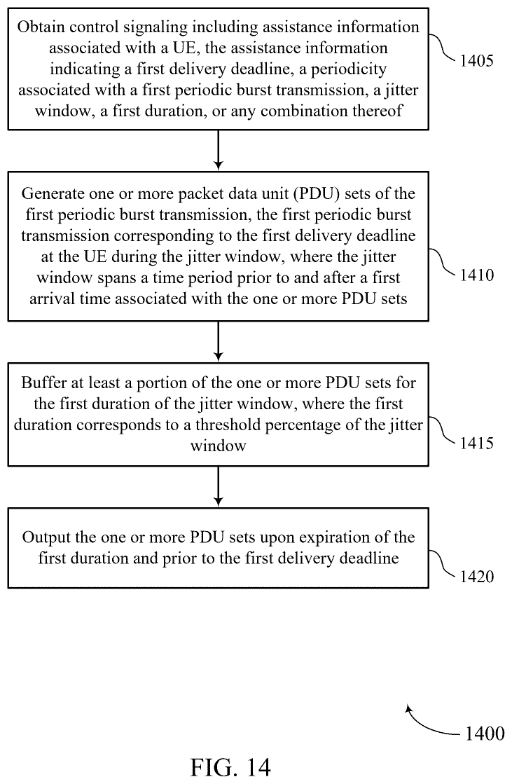

FIG. 14 shows a flowchart illustrating a method 1400 that supports mitigating jitter in communications in accordance with one or more aspects of the present disclosure. The operations of the method 1400 may be implemented by a network entity, such as an AS, or its components as described herein. For example, the operations of the method 1400 may be performed by a network entity as described with reference to FIGS. 1 through 12. In some examples, a network entity may execute a set of instructions to control the functional elements of the network entity to perform the described functions. Additionally, or alternatively, the network entity may perform aspects of the described functions using special-purpose hardware.

At 1405, the method may include obtaining control signaling including assistance information associated with a UE, the assistance information indicating a first delivery deadline (e.g., the delivery deadlines 305 as described herein with reference to FIGS. 3 and 4), a periodicity associated with a first periodic burst transmission (e.g., the bursts 230 as described herein with reference to FIG. 2), a jitter window (e.g., the jitter window 315 as described herein with reference to FIG. 3), a first duration, or any combination thereof. The operations of 1405 may be performed in accordance with examples as disclosed herein, such as disclosed in operation 515 of FIG. 5. In some examples, aspects of the operations of 1405 may be performed by an assistance information manager 1145 as described with reference to FIG. 11.

At 1410, the method may include generating one or more PDU sets of the first periodic burst transmission, the first periodic burst transmission corresponding to the first delivery deadline at the UE during the jitter window, where the jitter window spans a time period prior to and after a first arrival time (e.g., the average arrival time 317 as disclosed herein with reference to FIGS. 3 and 4) associated with the one or more PDU sets. The operations of 1410 may be performed in accordance with examples as disclosed herein, such as disclosed in operation 520 of FIG. 5. In some examples, aspects of the operations of 1410 may be performed by a frame generation manager 1125 as described with reference to FIG. 11.

At 1415, the method may include buffering at least a portion of the one or more PDU sets for the first duration of the jitter window, where the first duration corresponds to a threshold percentage of the jitter window. The operations of 1415 may be performed in accordance with examples as disclosed herein, such as disclosed in operation 530 of FIG. 5. In some examples, aspects of the operations of 1415 may be performed by a packet buffering manager 1130 as described with reference to FIG. 11.

At 1420, the method may include outputting the one or more PDU sets based on expiration of the first duration and prior to the first delivery deadline. The operations of 1420 may be performed in accordance with examples as disclosed herein, such as in operation 540 of FIG. 5. In some examples, aspects of the operations of 1420 may be performed by a periodic burst manager 1135 as described with reference to FIG. 11.

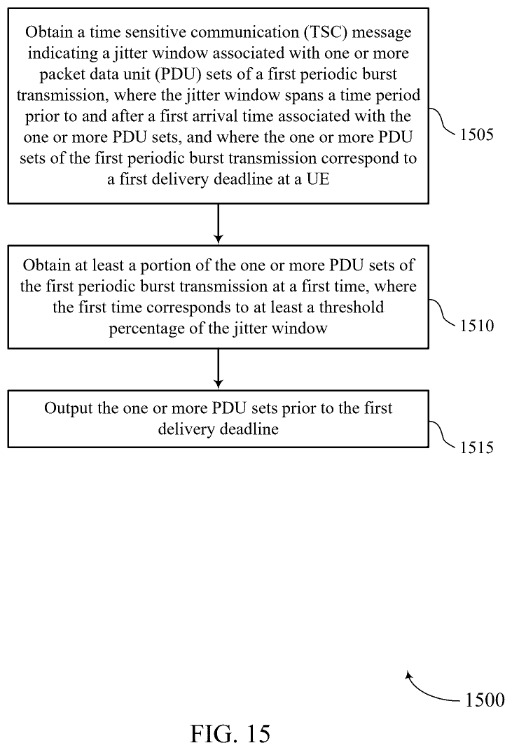

FIG. 15 shows a flowchart illustrating a method 1500 that supports mitigating jitter in communications in accordance with one or more aspects of the present disclosure. The operations of the method 1500 may be implemented by a network entity, such as a RAN, or its components as described herein. For example, the operations of the method 1500 may be performed by a network entity as described with reference to FIGS. 1 through 12. In some examples, a network entity may execute a set of instructions to control the functional elements of the network entity to perform the described functions. Additionally, or alternatively, the network entity may perform aspects of the described functions using special-purpose hardware.

At 1505, the method may include obtaining a TSC message indicating a jitter window (e.g., the jitter window 315 as described herein with reference to FIG. 3) associated with one or more PDU sets (e.g., PDU sets 235 as described herein with reference to FIG. 2) of a first periodic burst transmission (e.g., the burst 230 as described herein with reference to FIG. 2), where the jitter window spans a time period prior to and after a first arrival time (e.g., the average arrival time 317 as described herein with reference to FIGS. 3 and 4) associated with the one or more PDU sets, and where the one or more PDU sets of the first periodic burst transmission correspond to a first delivery deadline (e.g., the delivery deadline 305 as described herein with reference to FIGS. 3 and 4) at a UE. The operations of 1505 may be performed in accordance with examples as disclosed herein, such as disclosed in operation 550 of FIG. 5. In some examples, aspects of the operations of 1505 may be performed by an TSC messaging manager 1140 as described with reference to FIG. 11.

At 1510, the method may include obtaining at least a portion of the one or more PDU sets of the first periodic burst transmission at a first time (e.g., such as the time of arrival of the bursts 230 as described herein with reference to FIGS. 3 and 4), where the first time corresponds to at least a threshold percentage of the jitter window. The operations of 1510 may be performed in accordance with examples as disclosed herein, such as disclosed in operation 555 of FIG. 5. In some examples, aspects of the operations of 1510 may be performed by a periodic burst manager 1135 as described with reference to FIG. 11.

At 1515, the method may include outputting the one or more PDU sets prior to the first delivery deadline. The operations of 1515 may be performed in accordance with examples as disclosed herein, such as disclosed in operation 570 of FIG. 5. In some examples, aspects of the operations of 1515 may be performed by a periodic burst manager 1135 as described with reference to FIG. 11.

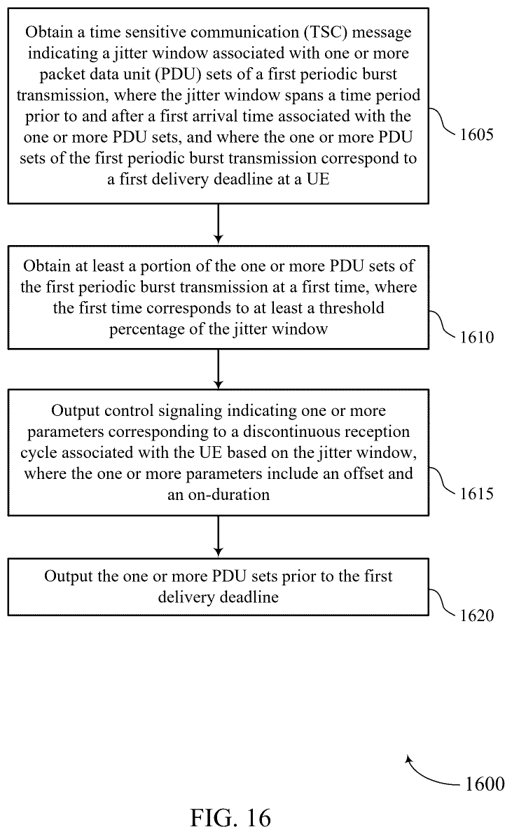

FIG. 16 shows a flowchart illustrating a method 1600 that supports mitigating jitter in communications in accordance with one or more aspects of the present disclosure. The operations of the method 1600 may be implemented by a network entity, such as a RAN, or its components as described herein. For example, the operations of the method 1600 may be performed by a network entity as described with reference to FIGS. 1 through 12. In some examples, a network entity may execute a set of instructions to control the functional elements of the network entity to perform the described functions. Additionally, or alternatively, the network entity may perform aspects of the described functions using special-purpose hardware.

At 1605, the method may include obtaining a TSC message indicating a jitter window (e.g., the jitter window 315 as described herein with reference to FIG. 3) associated with one or more PDU sets (e.g., PDU sets 235 as described herein with reference to FIG. 2) of a first periodic burst transmission (e.g., the burst 230 as described herein with reference to FIG. 2), where the jitter window spans a time period prior to and after a first arrival time (e.g., the average arrival time 317 as described herein with reference to FIGS. 3 and 4) associated with the one or more PDU sets, and where the one or more PDU sets of the first periodic burst transmission correspond to a first delivery deadline (e.g., the delivery deadline 305 as described herein with reference to FIGS. 3 and 4) at a UE. The operations of 1605 may be performed in accordance with examples as disclosed herein, such as disclosed in operation 550 of FIG. 5. In some examples, aspects of the operations of 1605 may be performed by an TSC messaging manager 1140 as described with reference to FIG. 11.

At 1610, the method may include obtaining at least a portion of the one or more PDU sets of the first periodic burst transmission at a first time, where the first time corresponds to at least a threshold percentage of the jitter window. The operations of 1610 may be performed in accordance with examples as disclosed herein, such as disclosed in operation 555 of FIG. 5. In some examples, aspects of the operations of 1610 may be performed by a periodic burst manager 1135 as described with reference to FIG. 11.

At 1615, the method may include outputting control signaling indicating one or more parameters corresponding to a DRX (e.g., the eCDRX as disclosed herein with reference to FIGS. 3 and 4) associated with the UE based on the jitter window, where the one or more parameters include an offset (e.g., the offset 325 as described herein with reference to FIG. 4) and an on-duration (e.g., the on-duration 330 as described herein with reference to FIG. 4). The operations of 1615 may be performed in accordance with examples as disclosed herein, such as disclosed in operation 565 of FIG. 5. In some examples, aspects of the operations of 1615 may be performed by a DRX manager 1160 as described with reference to FIG. 11.

At 1620, the method may include outputting the one or more PDU sets prior to the first delivery deadline. The operations of 1620 may be performed in accordance with examples as disclosed herein, such as disclosed in operation 570 of FIG. 5. In some examples, aspects of the operations of 1620 may be performed by a periodic burst manager 1135 as described with reference to FIG. 11.

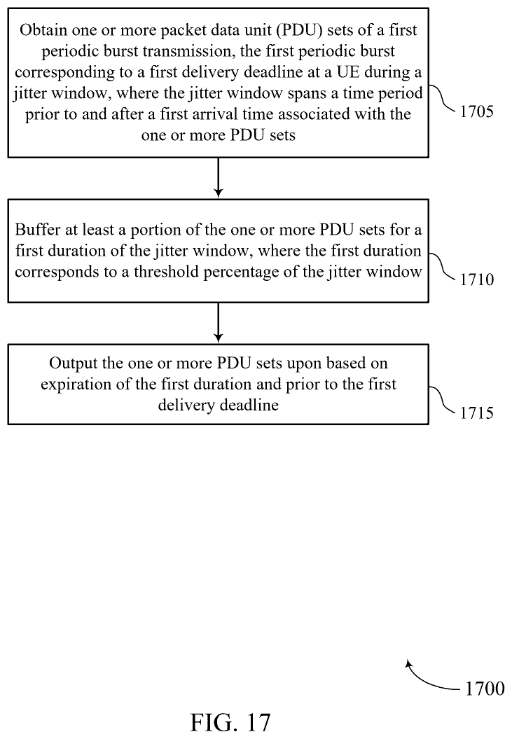

FIG. 17 shows a flowchart illustrating a method 1700 that supports mitigating jitter in communications in accordance with one or more aspects of the present disclosure. The operations of the method 1700 may be implemented by a network entity, such as a UPF, or its components as described herein. For example, the operations of the method 1700 may be performed by a network entity as described with reference to FIGS. 1 through 12. In some examples, a network entity may execute a set of instructions to control the functional elements of the network entity to perform the described functions. Additionally, or alternatively, the network entity may perform aspects of the described functions using special-purpose hardware.

At 1705, the method may include obtaining one or more PDU sets (e.g., PDU sets 235 as described herein with reference to FIG. 2) of a first periodic burst transmission (e.g., the burst 230 as described herein with reference to FIGS. 2 and 3), the first periodic burst corresponding to a first delivery deadline (e.g., the delivery deadline 305 as described herein with reference to FIGS. 3 and 4) at a UE during a jitter window (e.g., the jitter window 315 as described herein with reference to FIG. 3), where the jitter window spans a time period prior to and after a first arrival time (e.g., the average arrival time 317 as described herein with reference to FIGS. 3 and 4) associated with the one or more PDU sets. The operations of 1705 may be performed in accordance with examples as disclosed herein, such as disclosed in operation 730 of FIG. 7. In some examples, aspects of the operations of 1705 may be performed by a periodic burst manager 1135 as described with reference to FIG. 11.

At 1710, the method may include buffering at least a portion of the one or more PDU sets for a first duration of the jitter window, where the first duration corresponds to a threshold percentage of the jitter window. The operations of 1710 may be performed in accordance with examples as disclosed herein, such as disclosed in operation 740 of FIG. 7. In some examples, aspects of the operations of 1710 may be performed by a packet buffering manager 1130 as described with reference to FIG. 11.

At 1715, the method may include outputting the one or more PDU sets based on expiration of the first duration and prior to the first delivery deadline. The operations of 1715 may be performed in accordance with examples as disclosed herein, such as disclosed in operation 755 of FIG. 7. In some examples, aspects of the operations of 1715 may be performed by a periodic burst manager 1135 as described with reference to FIG. 11.

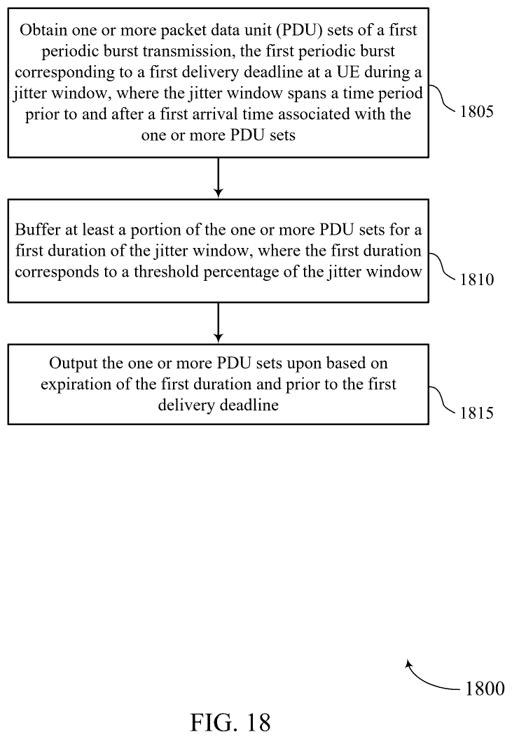

FIG. 18 shows a flowchart illustrating a method 1800 that supports mitigating jitter in communications in accordance with one or more aspects of the present disclosure. The operations of the method 1800 may be implemented by a network entity, such as a RAN, or its components as described herein. For example, the operations of the method 1800 may be performed by a network entity as described with reference to FIGS. 1 through 12. In some examples, a network entity may execute a set of instructions to control the functional elements of the network entity to perform the described functions. Additionally, or alternatively, the network entity may perform aspects of the described functions using special-purpose hardware.

At 1805, the method may include obtaining one or more PDU sets (e.g., PDU sets 235 as described herein with reference to FIG. 2) of a first periodic burst transmission (e.g., the burst 230 as described herein with reference to FIGS. 2 and 3), the first periodic burst corresponding to a first delivery deadline (e.g., the delivery deadline 305 as described herein with reference to FIGS. 3 and 4) at a UE during a jitter window (e.g., the jitter window 315 as described herein with reference to FIG. 3), where the jitter window spans a time period prior to and after a first arrival time (e.g., the average arrival time 317 as described herein with reference to FIGS. 3 and 4) associated with the one or more PDU sets. The operations of 1805 may be performed in accordance with examples as disclosed herein, such as disclosed in operation 830 of FIG. 8. In some examples, aspects of the operations of 1805 may be performed by a periodic burst manager 1135 as described with reference to FIG. 11.

At 1810, the method may include buffering at least a portion of the one or more PDU sets for a first duration of the jitter window, where the first duration corresponds to a threshold percentage of the jitter window. The operations of 1810 may be performed in accordance with examples as disclosed herein, such as disclosed in operation 840 of FIG. 8. In some examples, aspects of the operations of 1810 may be performed by a packet buffering manager 1130 as described with reference to FIG. 11.

At 1815, the method may include outputting the one or more PDU sets based on expiration of the first duration and prior to the first delivery deadline. The operations of 1815 may be performed in accordance with examples as disclosed herein, such as disclosed in operation 850 of FIG. 8. In some examples, aspects of the operations of 1815 may be performed by a periodic burst manager 1135 as described with reference to FIG. 11.

The following provides an overview of aspects of the present disclosure:

Aspect 1: A method for wireless communications at an AS, comprising: generating one or more PDU sets of a first periodic burst transmission, the first periodic burst transmission corresponding to a first delivery deadline at a UE during a jitter window, wherein the jitter window spans a time period prior to and after a first arrival time associated with the one or more PDU sets; buffering at least a portion of the one or more PDU sets for a first duration of the jitter window, wherein the first duration corresponds to a threshold percentage of the jitter window; and outputting the one or more PDU sets upon expiration of the first duration and prior to the first delivery deadline.

Aspect 2: The method of aspect 1, further comprising: obtaining control signaling comprising assistance information associated with the UE, the assistance information indicating the first delivery deadline, a periodicity associated with the first periodic burst transmission, the jitter window, the first duration, or any combination thereof, wherein buffering at least the portion of the one or more PDU sets is in accordance with the assistance information.

Aspect 3: The method of any of aspects 1 through 2, further comprising: outputting a TSC message comprising an indication of the jitter window based at least in part on generating the one or more PDU sets of the first periodic burst transmission.

Aspect 4: The method of any of aspects 1 through 3, wherein buffering the portion of the one or more PDU sets comprises: starting a timer in response to generating the one or more PDU sets, the timer being set to the first duration, wherein buffering the portion of the one or more PDU sets is based at least in part on starting the timer, and wherein outputting the one or more PDU sets is based at least in part on expiration of the timer.

Aspect 5: The method of any of aspects 1 through 3, wherein buffering the portion of the one or more PDU sets comprises: identifying a start time associated with the one or more PDU sets in response to generating the one or more PDU sets; and delaying the portion of the one or more PDU sets from the identified start time for the first duration, wherein outputting the one or more PDU sets is based at least in part on the expiration of the first duration.

Aspect 6: The method of any of aspects 1 through 5, further comprising: measuring a second jitter window associated with communication of a second periodic burst transmission, the second periodic burst transmission being prior to the first periodic burst transmission; and estimating the jitter window associated with the first periodic burst transmission based at least in part on the second jitter window.

Aspect 7: The method of aspect 6, further comprising: storing the second jitter window based at least in part on measuring the second jitter window, wherein estimating the jitter window is based at least in part on the storing.

Aspect 8: The method of aspect 7, wherein the second jitter window is stored according to an XR configuration in a memory of the AS.

Aspect 9: The method of any of aspects 7 through 8, further comprising: measuring a respective jitter window associated with communication of one or more additional periodic burst transmissions, the one or more additional periodic burst transmissions being prior to the first periodic burst transmission and after the second periodic burst transmission; and updating the second jitter window stored in the AS based at least in part on measuring the respective jitter windows of each of the one or more additional periodic burst transmissions, wherein estimating the jitter window is based at least in part on updating the second jitter window.

Aspect 10: The method of any of aspects 6 through 9, wherein the second jitter window is based at least in part on an operating condition of the AS, a data rate of the second periodic burst transmission, a periodicity of the second periodic burst transmission, or a combination thereof.

Aspect 11: The method of any of aspects 1 through 10, further comprising: measuring a duration associated with generating the one or more PDU sets of the first periodic burst transmission; and estimating the jitter window based at least in part on the duration associated with generating the one or more PDU sets.

Aspect 12: The method of aspect 11, wherein estimating the jitter window using the duration is based at least in part on the duration being less than a threshold duration.

Aspect 13: The method of any of aspects 11 through 12, wherein the duration associated with generating the one or more PDU sets of the first periodic burst transmission is based at least in part on a data rate associated with the first periodic burst transmission, a periodicity of the first periodic burst transmission, or a combination thereof.

Aspect 14: The method of any of aspects 1 through 13, further comprising: identifying a second jitter window associated with a second periodic burst transmission, the second periodic burst transmission being prior to the first periodic burst transmission; measuring a duration associated with generating the one or more PDU sets of the first periodic burst transmission; and estimating the jitter window based at least in part on the duration associated with generating the one or more PDU sets and the second jitter window associated with the second periodic burst transmission.

Aspect 15: The method of any of aspects 1 through 14, wherein generating the one or more PDU sets comprises: rendering at least a portion of a video frame associated with XR communications; encoding, based at least in part on the rendering, the portion of the video frame; and packetizing, based at least in part on the encoding, the portion of the video frame to obtain the one or more PDU sets of the first periodic burst transmission.

Aspect 16: The method of any of aspects 1 through 15, wherein the first arrival time is an average arrival time measured across one or more periodic burst transmissions, the one or more periodic burst transmissions occurring prior to the first periodic burst transmission.

Aspect 17: A method for wireless communications at a RAN, comprising: obtaining a TSC message indicating a jitter window associated with one or more PDU sets of a first periodic burst transmission, wherein the jitter window spans a time period prior to and after a first arrival time associated with the one or more PDU sets, and wherein the one or more PDU sets of the first periodic burst transmission correspond to a first delivery deadline at a UE; obtaining at least a portion of the one or more PDU sets of the first periodic burst transmission at a first time, wherein the first time corresponds to at least a threshold percentage of the jitter window; and outputting the one or more PDU sets prior to the first delivery deadline.

Aspect 18: The method of aspect 17, further comprising: outputting control signaling indicating one or more parameters corresponding to a DRX cycle associated with the UE based at least in part on the jitter window, wherein the one or more parameters comprise an offset and an on-duration.

Aspect 19: The method of aspect 18, wherein the offset is based at least in part on the jitter window, a remaining jitter, a jitter associated with communications between the RAN and a UPF, a first margin, or a combination thereof, the remaining jitter corresponding to a difference between the jitter window and the threshold percentage of the jitter window, and the on-duration is based at least in part on the remaining jitter, the jitter associated with the communications between the RAN and the UPF, a second margin, or a combination thereof.

Aspect 20: The method of aspect 19, wherein the TSC message further indicates the remaining jitter, the jitter associated with the communications between the RAN and the UPF, or both.

Aspect 21: The method of any of aspects 19, further comprising: measuring the remaining jitter, the jitter associated with the communications between the RAN and the UPF, or both, wherein the DRX cycle is based at least in part on the measuring.

Aspect 22: A method for wireless communications at a UPF, comprising: obtaining one or more PDU sets of a first periodic burst transmission, the first periodic burst corresponding to a first delivery deadline at a UE during a jitter window, wherein the jitter window spans a time period prior to and after a first arrival time associated with the one or more PDU sets; buffering at least a portion of the one or more PDU sets for a first duration of the jitter window, wherein the first duration corresponds to a threshold percentage of the jitter window; and outputting the one or more PDU sets upon based at least in part on expiration of the first duration and prior to the first delivery deadline.

Aspect 23: A method for wireless communications at a RAN, comprising: obtaining one or more PDU sets of a first periodic burst transmission, the first periodic burst corresponding to a first delivery deadline at a UE during a jitter window, wherein the jitter window spans a time period prior to and after a first arrival time associated with the one or more PDU sets; buffering at least a portion of the one or more PDU sets for a first duration of the jitter window, wherein the first duration corresponds to a threshold percentage of the jitter window; and outputting the one or more PDU sets upon based at least in part on expiration of the first duration and prior to the first delivery deadline.

Aspect 24: An AS for wireless communications, comprising one or more memories storing processor-executable code, and one or more processors coupled with the one or more memories and individually or collectively operable to execute the code to cause the AS to perform a method of any of aspects 1 through 16.

Aspect 25: An AS for wireless communications, comprising at least one means for performing a method of any of aspects 1 through 16.

Aspect 26: A non-transitory computer-readable medium storing code for wireless communications, the code comprising instructions executable by one or more processors to perform a method of any of aspects 1 through 16.

Aspect 27: A RAN for wireless communications, comprising one or more memories storing processor-executable code, and one or more processors coupled with the one or more memories and individually or collectively operable to execute the code to cause the RAN to perform a method of any of aspects 17 through 21.

Aspect 28: A RAN for wireless communications, comprising at least one means for performing a method of any of aspects 17 through 21.

Aspect 29: A non-transitory computer-readable medium storing code for wireless communications, the code comprising instructions executable by one or more processors to perform a method of any of aspects 17 through 21.

Aspect 30: A UPF for wireless communications, comprising one or more memories storing processor-executable code, and one or more processors coupled with the one or more memories and individually or collectively operable to execute the code to cause the UPF to perform a method of the aspect 22.

Aspect 31: A UPF for wireless communications, comprising at least one means for performing a method of the aspect 22.

Aspect 32: A non-transitory computer-readable medium storing code for wireless communications, the code comprising instructions executable by one or more processors to perform a method of the aspect 22.

Aspect 33: A RAN for wireless communications, comprising one or more memories storing processor-executable code, and one or more processors coupled with the one or more memories and individually or collectively operable to execute the code to cause the RAN to perform a method of the aspect 23.

Aspect 34: A RAN for wireless communications, comprising at least one means for performing a method of the aspect 23.

Aspect 35: A non-transitory computer-readable medium storing code for wireless communications, the code comprising instructions executable by one or more processors to perform a method of any of the aspect 23.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An application server, comprising:
one or more processors;
one or more memories coupled with the one or more processors; and
one or more processor-readable instructions stored in the one or more memories and executable by the one or more processors individually or collectively to cause the application server to:
generate one or more packet data unit (PDU) sets of a first periodic burst transmission, the first periodic burst transmission corresponding to a first delivery deadline at a user equipment (UE) during a jitter window, wherein the jitter window spans a time period prior to and after a first arrival time associated with the one or more PDU sets;
buffer at least a portion of the one or more PDU sets for a first duration of the jitter window, wherein the first duration corresponds to a threshold percentage of the jitter window; and
output the one or more PDU sets based at least in part on expiration of the first duration and prior to the first delivery deadline.

2. The application server of claim 1, wherein the one or more processors are individually or collectively further operable to execute the one or more processor-readable instructions to cause the application server to:
obtain control signaling comprising assistance information associated with the UE, the assistance information indicating the first delivery deadline, a periodicity associated with the first periodic burst transmission, the jitter window, the first duration, or any combination thereof, wherein buffering at least the portion of the one or more PDU sets is in accordance with the assistance information.

3. The application server of claim 1, wherein the one or more processors are individually or collectively further operable to execute the one or more processor-readable instructions to cause the application server to:
output a time sensitive communication (TSC) message comprising an indication of the jitter window based at least in part on generating the one or more PDU sets of the first periodic burst transmission.

4. The application server of claim 1, wherein, to buffer the portion of the one or more PDU sets, the one or more processors are individually or collectively operable to execute the one or more processor-readable instructions to cause the application server to:
start a timer in response to generating the one or more PDU sets, the timer being set to the first duration, wherein buffering the portion of the one or more PDU sets is based at least in part on starting the timer, and wherein outputting the one or more PDU sets is based at least in part on an expiration of the timer.

5. The application server of claim 1, wherein, to buffer the portion of the one or more PDU sets, the one or more processors are individually or collectively operable to execute the one or more processor-readable instructions to cause the application server to:
identify a start time associated with the one or more PDU sets in response to generating the one or more PDU sets; and
delay the portion of the one or more PDU sets from the identified start time for the first duration, wherein outputting the one or more PDU sets is based at least in part on the expiration of the first duration.

6. The application server of claim 1, wherein the one or more processors are individually or collectively further operable to execute the one or more processor-readable instructions to cause the application server to:
measure a second jitter window associated with communication of a second periodic burst transmission, the second periodic burst transmission being prior to the first periodic burst transmission; and
estimate the jitter window associated with the first periodic burst transmission based at least in part on the second jitter window.

7. The application server of claim 6, wherein the one or more processors are individually or collectively further operable to execute the one or more processor-readable instructions to cause the application server to:
store the second jitter window based at least in part on measuring the second jitter window, wherein estimating the jitter window is based at least in part on the storing.

8. The application server of claim 7, wherein the second jitter window is stored according to an extended reality (XR) configuration in a memory of the application server.

9. The application server of claim 7, wherein the one or more processors are individually or collectively further operable to execute the one or more processor-readable instructions to cause the application server to:
measure a respective jitter window associated with communication of one or more additional periodic burst transmissions, the one or more additional periodic burst transmissions being prior to the first periodic burst transmission and after the second periodic burst transmission; and
update the second jitter window stored in the application server based at least in part on measuring the respective jitter windows of each of the one or more additional periodic burst transmissions, wherein estimating the jitter window is based at least in part on updating the second jitter window.

10. The application server of claim 1, wherein the one or more processors are individually or collectively further operable to execute the one or more processor-readable instructions to cause the application server to:
measure a duration associated with generating the one or more PDU sets of the first periodic burst transmission; and
estimate the jitter window based at least in part on the duration associated with generating the one or more PDU sets.

11. The application server of claim 1, wherein the one or more processors are individually or collectively further operable to execute the one or more processor-readable instructions to cause the application server to:
identify a second jitter window associated with a second periodic burst transmission, the second periodic burst transmission being prior to the first periodic burst transmission;
measure a duration associated with generating the one or more PDU sets of the first periodic burst transmission; and
estimate the jitter window based at least in part on the duration associated with generating the one or more PDU sets and the second jitter window associated with the second periodic burst transmission.

12. The application server of claim 1, wherein, to generate the one or more PDU sets, the one or more processors are individually or collectively operable to execute the one or more processor-readable instructions to cause the application server to:
render at least a portion of a video frame associated with extended reality (XR) communications;
encode, based at least in part on the rendering, the portion of the video frame; and
packetizing, based at least in part on the encoding, the portion of the video frame to obtain the one or more PDU sets of the first periodic burst transmission.

13. A user plane function (UPF), comprising:
one or more processors;
one or more memories coupled with the one or more processors; and
one or more processor-readable instructions stored in the one or more memories and executable by the one or more processors individually or collectively to cause the UPF to:
obtain one or more packet data unit (PDU) sets of a first periodic burst transmission, the first periodic burst transmission corresponding to a first delivery deadline at a user equipment (UE) during a jitter window, wherein the jitter window spans a time period prior to and after a first arrival time associated with the one or more PDU sets;
buffer at least a portion of the one or more PDU sets for a first duration of the jitter window, wherein the first duration corresponds to a threshold percentage of the jitter window; and
output the one or more PDU sets based at least in part on expiration of the first duration and prior to the first delivery deadline.

14. The UPF of claim 13, wherein the one or more processors are individually or collectively further operable to execute the one or more processor-readable instructions to cause the UPF to:
obtain control signaling comprising assistance information associated with the UE, the assistance information indicating the first delivery deadline, a periodicity associated with the first periodic burst transmission, the jitter window, the first duration, or any combination thereof, wherein buffering at least the portion of the one or more PDU sets is in accordance with the assistance information.

15. The UPF of claim 13, wherein the one or more processors are individually or collectively further operable to execute the one or more processor-readable instructions to cause the UPF to:
obtain a time sensitive communication (TSC) message comprising an indication of the jitter window based at least in part on generating the one or more PDU sets of the first periodic burst transmission.

16. The UPF of claim 13, wherein, to buffer the portion of the one or more PDU sets, the one or more processors are individually or collectively operable to execute the one or more processor-readable instructions to cause the UPF to:
start a timer in response to generating the one or more PDU sets, the timer being set to the first duration, wherein buffering the portion of the one or more PDU sets is based at least in part on starting the timer, and wherein outputting the one or more PDU sets is based at least in part on an expiration of the timer.

17. The UPF of claim 13, wherein, to buffer the portion of the one or more PDU sets, the one or more processors are individually or collectively operable to execute the one or more processor-readable instructions to cause the UPF to:
identify a start time associated with the one or more PDU sets in response to generating the one or more PDU sets; and
delay the portion of the one or more PDU sets from the identified start time for the first duration, wherein outputting the one or more PDU sets is based at least in part on the expiration of the first duration.

18. A radio access network (RAN), comprising:
one or more processors;
one or more memories coupled with the one or more processors; and
one or more processor-readable instructions stored in the one or more memories and executable by the one or more processors individually or collectively to cause the RAN to:
obtain one or more packet data unit (PDU) sets of a first periodic burst transmission, the first periodic burst transmission corresponding to a first delivery deadline at a user equipment (UE) during a jitter window, wherein the jitter window spans a time period prior to and after a first arrival time associated with the one or more PDU sets;
buffer at least a portion of the one or more PDU sets for a first duration of the jitter window, wherein the first duration corresponds to a threshold percentage of the jitter window; and
output the one or more PDU sets based at least in part on expiration of the first duration and prior to the first delivery deadline.

19. The RAN of claim 18, wherein the one or more processors are individually or collectively further operable to execute the one or more processor-readable instructions to cause the RAN to:
output control signaling indicating one or more parameters corresponding to a discontinuous reception cycle associated with the UE based at least in part on the jitter window, wherein the one or more parameters comprise an offset and an on-duration.

20. The RAN of claim 18, wherein the one or more processors are individually or collectively further operable to execute the one or more processor-readable instructions to cause the RAN to:
obtain control signaling comprising assistance information associated with the UE, the assistance information indicating the first delivery deadline, a periodicity associated with the first periodic burst transmission, the jitter window, the first duration, or any combination thereof, wherein buffering at least the portion of the one or more PDU sets is in accordance with the assistance information.
